(19) United States
(12) Patent Application Publication
(10) Pub. No.: US 2023/0004791 A1
(43) Pub. Date: Jan. 5, 2023

(54) COMPRESSED MATRIX REPRESENTATIONS OF NEURAL NETWORK ARCHITECTURES BASED ON SYNAPTIC CONNECTIVITY

(71) Applicant: X Development LLC, Mountain View, CA (US)

(72) Inventors: Yu Feng, Dublin, CA (US); Lam Thanh Nguyen, Mountain View, CA (US)

(21) Appl. No.: 17/364,444

(22) Filed: Jun. 30, 2021

(51) Int. Cl. G06N 3/08; G06N 3/04

(52) U.S. Cl. CPC G06N 3/08; G06N 3/04

(57) ABSTRACT

Methods, systems, and apparatus, including computer programs encoded on a computer storage medium, for implementing brain emulation neural networks using compressed matrix representations. One of the methods includes obtaining a network input; and processing the network input using a neural network to generate a network output, comprising: processing the network input using an input subnetwork of the neural network to generate an embedding of the network input; and processing the embedding of the network input using a brain emulation subnetwork of the neural network, wherein the brain emulation subnetwork has a brain emulation neural network architecture that represents synaptic connectivity between a plurality of biological neurons in a brain of a biological organism, the processing comprising: obtaining a compressed matrix representation of a sparse matrix of brain emulation parameters; and applying the compressed matrix representation to the embedding of the network input to generate a brain emulation subnetwork output.

### BACKGROUND

This specification relates to processing data using machine learning models.

Machine learning models receive an input and generate an output, e.g., a predicted output, based on the received input. Some machine learning models are parametric models and generate the output based on the received input and on values of the parameters of the model.

Some machine learning models are deep models that employ multiple layers of computational units to generate an output for a received input. For example, a deep neural network is a deep machine learning model that includes an output layer and one or more hidden layers that each apply a non-linear transformation to a received input to generate an output.

### SUMMARY

This specification describes systems implemented as computer programs on one or more computers in one or more locations for implementing neural networks that include one or more brain emulation neural network layers whose parameters have been determined according to the synaptic connectivity between neurons in the brain of a biological organism, e.g., a fly.

For example, the parameters of a brain emulation neural network layer can be determined using a synaptic connectivity graph. A synaptic connectivity graph refers to a graph representing the structure of synaptic connections between neurons in the brain of a biological organism, e.g., a fly. For example, the synaptic connectivity graph can be generated by processing a synaptic resolution image of the brain of a biological organism.

For convenience, throughout this specification, an artificial neural network layer whose parameters have been determined using synaptic connectivity is called a “brain emulation” neural network layer. An artificial neural network having at least one brain emulation neural network layer is called a “brain emulation” neural network. Identifying an artificial neural network as a “brain emulation” neural network is intended only to conveniently distinguish such neural networks from other neural networks (e.g., with hand-engineered architectures), and should not be interpreted as limiting the nature of the operations that can be performed by the neural network or otherwise implicitly characterizing the neural network.

The architecture of a brain emulation neural network layer of a brain emulation neural network can be represented using a weight matrix that includes the parameters of the brain emulation neural network layer. When the brain emulation neural network processes a network input, the brain emulation neural network layer is configured to process a layer input generated from the network input by multiplying the weight matrix against the layer input to generate a layer output.

The weight matrix of a brain emulation neural network layer can have a high sparsity; that is, a high proportion of the elements of the weight matrix can have a value of zero. In these cases, the weight matrix can be represented using a compressed matrix representation.

In this specification, a compressed matrix representation of a matrix is any representation of the matrix that leverages the sparsity of the matrix to reduce the number of bits required to represent the matrix. For example, a compressed matrix representation can explicitly identify only a proper subset of the elements of the matrix, and not explicitly identify the other elements of the matrix. In some implementations, the elements of the sparse matrix that are not explicitly identified in the compressed matrix representation all have value zero, and some or all of the elements of the sparse matrix that are explicitly identified in the compressed matrix representation have respective non-zero values. In some implementations, the compressed matrix representation only explicitly identifies the elements of the matrix that have a non-zero value. In some other implementations, the compressed matrix representation explicitly identifies the elements of the matrix that have a non-zero value, while also explicitly identifying a proper subset of the elements of the matrix that have a value of zero. As a particular example, during training of a neural network that includes a weight matrix of parameters represented using a compressed matrix representation, some of the parameters of the weight matrix that are explicitly identified in the compressed matrix representation may temporarily have values of zero, e.g., if a parameter update causes the parameter to change from a non-zero value to a value of zero. Specific examples are described in more detail below.

For example, the compressed matrix representation can be a compressed list (often called “COO”) representation, a compressed sparse row (CSR) representation, or a compressed sparse column (CSC) representation.

The weight matrix of a brain emulation neural network layer can be stored using a compressed matrix representation, applied using a compressed matrix representation, or both.

This specification also describes systems for training a neural network that includes one or more such brain emulation neural network layers, including updating the values of the parameters that are represented used the compressed matrix representation.

Particular embodiments of the subject matter described in this specification can be implemented so as to realize one or more of the following advantages.

The systems described in this specification can train and implement a brain emulation neural network using a compressed matrix representation. As described in this specification, brain emulation neural networks can achieve a higher performance (e.g., in terms of prediction accuracy), than other neural networks of an equivalent size (e.g., in terms of number of parameters). Put another way, brain emulation neural networks that have a relatively small size (e.g., 100 or 1000 parameters) can achieve comparable performance with other neural networks that are much larger (e.g., thousands or millions of parameters). Therefore, using techniques described in this specification, a system can implement a highly efficient, low-latency, and low-power-consuming neural network. That is, a system that implements a brain emulation neural network can reduce the use of computational resources, e.g., memory and computational power, relative to systems that implement other neural networks.

Leveraging compressed matrix representations can further improve the efficiency of a system configured to execute a brain emulation neural network. In some implementations, brain emulation neural networks can have a very high sparsity, representing the fact that most pairs of neurons in the brain of a biological organism do not share a synaptic connection. Thus, brain emulation neural networks in particular can enjoy significant efficiency improvements from compressed matrix representations. The reduced size of the compressed matrix representation of a weight matrix of a brain emulation neural network layer improves the memory efficiency, computational efficiency, and time efficiency of processing layer inputs using the brain emulation neural network layer. Furthermore, this improved efficiency can further reduce the amount of power necessary for the system to execute the brain emulation neural network.

These efficiency gains can be especially important in low-resource or low-memory environments, e.g., on mobile devices or other edge devices. Additionally, these efficiency gains can be especially important in situations in which the brain emulation neural network is continuously processing network inputs, e.g., in an application that continuously processes input audio data to determine whether a “wakeup” phrase has been spoken by a user.

The systems described in this specification can implement a brain emulation neural network having an architecture specified by a synaptic connectivity graph derived from a synaptic resolution image of the brain of a biological organism. The brains of biological organisms may be adapted by evolutionary pressures to be effective at solving certain tasks, e.g., classifying objects or generating robust object representations, and brain emulation neural networks can share this capacity to effectively solve tasks. In particular, compared to other neural networks, e.g., with manually specified neural network architectures, brain emulation neural networks can require less training data, fewer training iterations, or both, to effectively solve certain tasks.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 and FIG. 2 illustrate example neural network computing systems.

FIG. 3 illustrates an example weight matrix of a brain emulation neural network layer determined using synaptic connectivity.

FIG. 4A illustrates an example of generating a brain emulation neural network based on a synaptic resolution image of the brain of a biological organism.

FIG. 4B shows an example data flow for generating a synaptic connectivity graph and a brain emulation neural network based on the brain of a biological organism.

FIG. 5 shows an example architecture mapping system.

FIG. 6 illustrates an example graph and an example sub-graph.

FIG. 7 is a flow diagram of an example process for implementing a brain emulation neural network layer using a compressed matrix representation.

FIG. 8 is a flow diagram of an example process for generating a brain emulation neural network.

FIG. 9 is a flow diagram of an example process for determining an artificial neural network architecture corresponding to a sub-graph of a synaptic connectivity graph.

FIG. 10 shows an example optimization system.

FIG. 11 is a block diagram of an example computer system.

Like reference numbers and designations in the various drawings indicate like elements.

### DETAILED DESCRIPTION

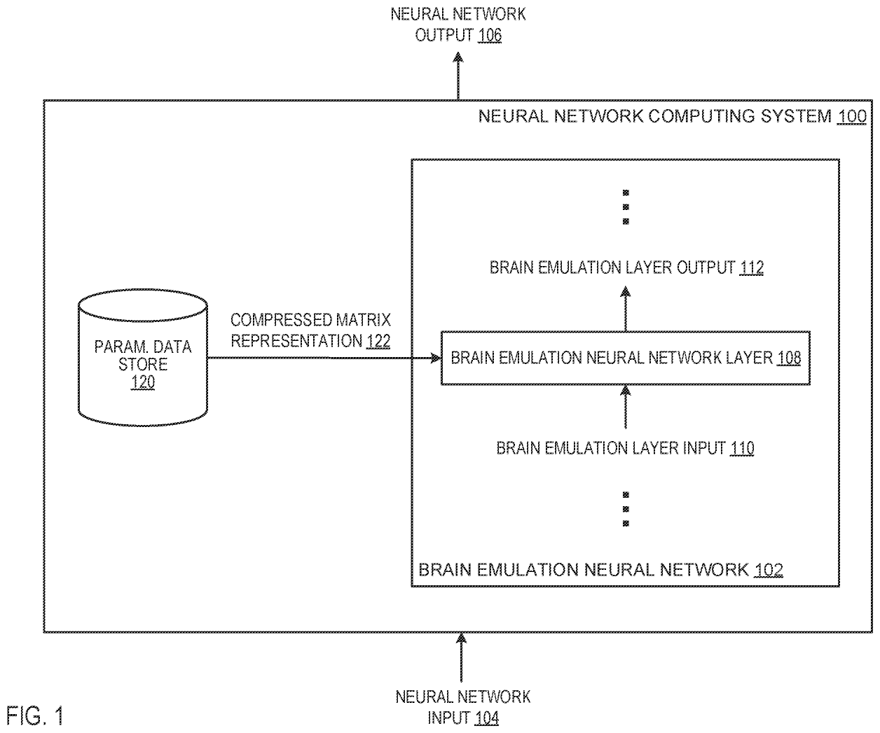

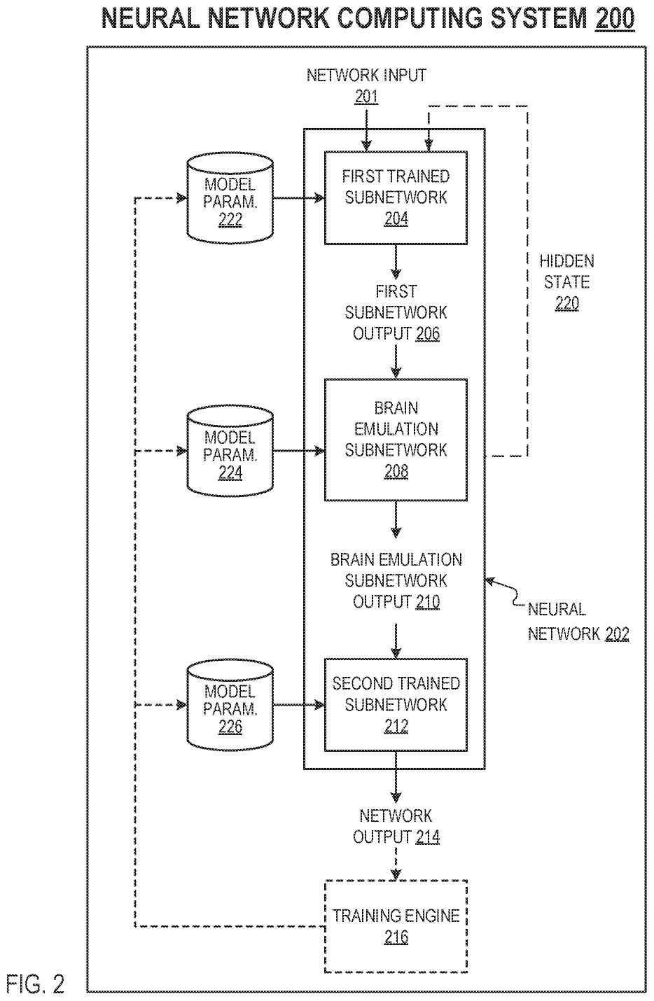

FIG. 1 and FIG. 2 show two examples of neural network computing systems for implementing neural networks that include at least one brain emulation neural network layers.

FIG. 1 shows an example neural network computing system 100. The neural network computing system 100 is an example of a system implemented as computer programs on one or more computers in one or more locations in which the systems, components, and techniques described below are implemented.

The neural network computing system 100 includes a brain emulation neural network 102. The brain emulation neural network 102 includes one or more brain emulation neural network layers (e.g., the brain emulation neural network layer 108). Optionally, the brain emulation neural network 102 can also include one or more other neural network layers, e.g., one or more feed-forward neural network layers, recurrent neural network layers, convolutional neural network layers, or any other appropriate type of neural network layer.

The brain emulation neural network 102 is configured to process a network input to generate a network output for a particular machine learning task. The network input for the brain emulation neural network 102 can be any kind of digital data input, and the network output for the brain emulation neural network 102 can be any kind of score, classification, or regression output based on the input. That is, the brain emulation neural network 102 can be configured for any appropriate machine learning tasks; example tasks are discussed below.

The brain emulation neural network layer 108 includes multiple brain emulation parameters, and is configured to process a brain emulation layer input 110, generated from the network input of the brain emulation neural network 102, and to generate a brain emulation layer output 112, which can be processed by subsequent neural network layers in the brain emulation neural network 102. In general, the brain emulation layer input 110 can be the network input to the brain emulation neural network 102 (i.e., if the brain emulation neural network layer 108 is the first layer in the brain emulation neural network 102) or the output of another layer of the brain emulation neural network 102. Similarly, the brain emulation layer output 112 can be the network output of the brain emulation neural network 102 (i.e., if the brain emulation neural network layer 108 is the final layer in the brain emulation neural network 102). The brain emulation layer input 110 and the brain emulation layer output 112 may be represented in any appropriate numerical format, for example, as vectors or as matrices.

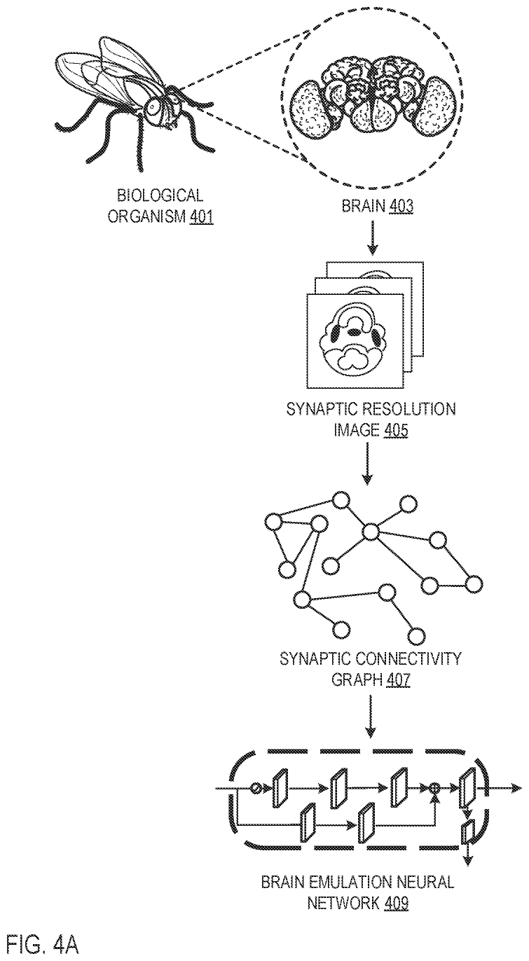

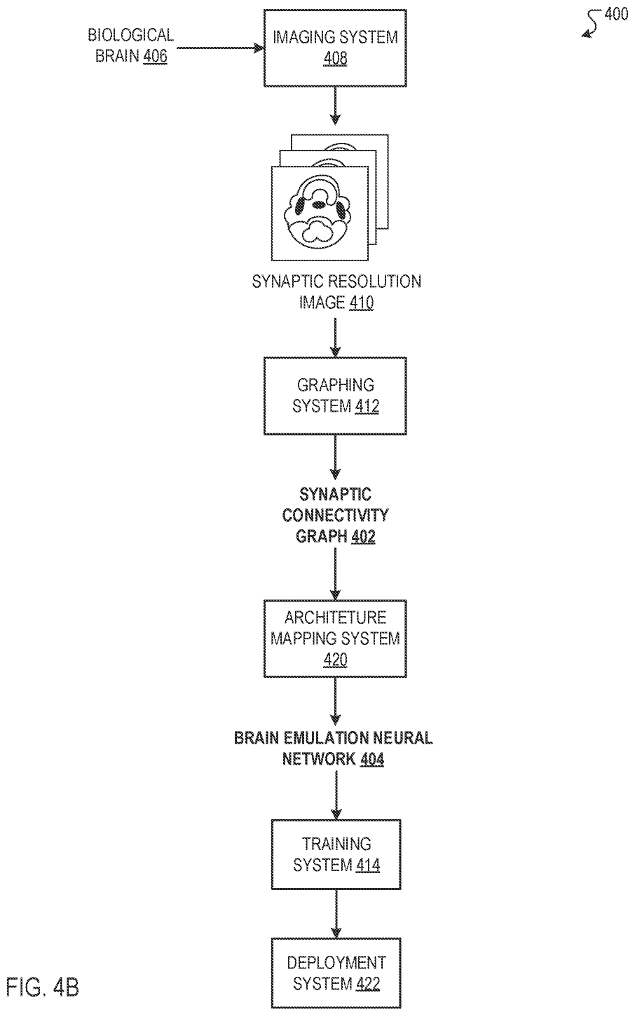

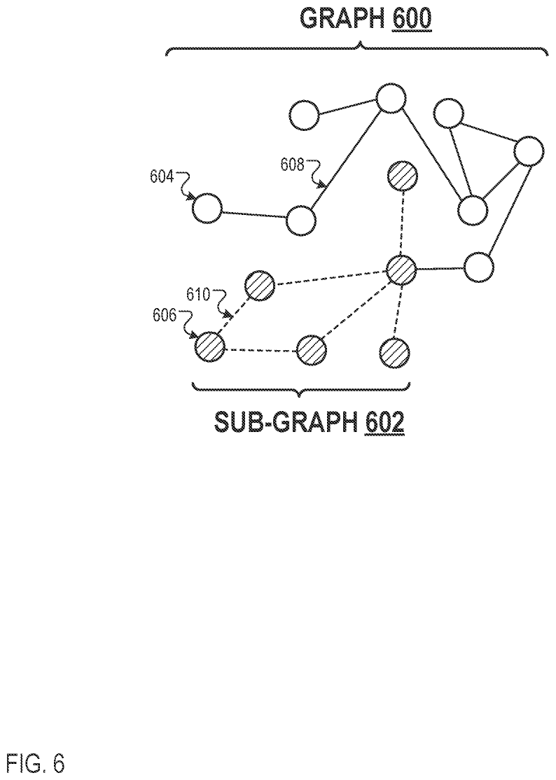

The brain emulation neural network layer 108 can have a brain emulation architecture that is based on a synaptic connectivity graph representing synaptic connectivity between neurons in the brain of a biological organism. An example process for determining a network architecture using a synaptic connectivity graph is described below with respect to FIG. 4B. In some implementations, the architecture of the brain emulation neural network layer 108 can be specified by the synaptic connectivity between neurons of a particular type in the brain, e.g., neurons from the visual system or the olfactory system. This process is described in more detail below with reference to FIG. 6.

In particular, the architecture of the brain emulation neural network layer 108 can be represented by a weight matrix that the brain emulation neural network layer 108 applies to the brain emulation layer input 110 to generate the brain emulation layer output 112. Each element of the weight matrix can be a respective brain emulation parameter of the brain emulation neural network layer 108. As a particular example, the brain emulation layer input 110 can be an N×1 vector of elements, the weight matrix of the brain emulation neural network layer 108 can be an M×N matrix of elements, and the brain emulation layer output 112 can be an M×1 vector of elements.

Each brain emulation parameter of the weight matrix can correspond to a pair of neurons in the brain of the biological organism, where the value of the brain emulation parameter characterizes a strength of a neuronal connection between the pair of neurons. In other words, each row and column of the weight matrix can correspond to a respective neuron in the brain of the biological organism, and the value of each brain emulation parameter can characterize a strength of a neuronal connection between (i) the neuron corresponding to the row of the brain emulation parameter and (ii) the neuron corresponding to the column of the brain emulation parameter.

In particular, the weight matrix can be an M×N matrix, where each of the M rows corresponds to a neuron in a first set of neurons and each of the N columns corresponds to a neuron in a second set of neurons in the brain of the biological organism. The first set of neurons and the second set of neurons can be overlapping (i.e., one or more neurons in the brain of the biological organism is in both sets) or disjoint (i.e., there does not exist a neuron in the brain of the biological organism that is in both sets). As a particular example, the first set and the second set can be the same. That is, the weight matrix can be an N×N matrix where the same neurons in the brain of the biological organism are represented by both the rows and the columns of the weight matrix. The process of generating the weight matrix is described in more detail below.

Because many pairs of neurons in the brain of the biological organism may not share a synaptic connection at all, many brain emulation parameters of the weight matrix of the brain emulation neural network layer may have values of zero. In other words, the sparsity of the weight matrix may be high. In this specification, the sparsity of a matrix is a measure of the number or proportion of zero elements in the matrix. In this specification, a matrix may be referred to as a “sparse matrix” if the sparsity of the matrix satisfies a certain threshold. For example, in some implementations the weight matrix of a brain emulation neural network layer has a sparsity of 50% (i.e., where 50% of the brain emulation parameters of the weight matrix have a value of zero), 60%, 70%, 80%, 90%, 95%, or 99%.

Therefore, the neural network computing system 100 can store a compressed matrix representation 122 of the weight matrix of the brain emulation neural network layer 108. As described above, the compressed matrix representation 122 has a smaller memory footprint than the weight matrix when represented fully (i.e., as an array with all zero values represented) because only a proper subset of the brain emulation parameters of the weight matrix are explicitly identified (i.e., represented) by the compressed matrix representation.

As described above, in some implementations, the compressed matrix representation 122 only explicitly identifies the brain emulation parameters that have a non-zero value. That is, the compressed matrix representation 122 does not explicitly represent the brain emulation parameters that have values of zero.

In some other implementations, the compressed matrix representation 122 explicitly identifies both (i) each brain emulation parameter that has a non-zero value, and (ii) a proper subset of the brain emulation parameters that have a value of zero. For example, as described in more detail below, during training of the neural network 102, the compressed matrix representation may temporarily explicitly represent brain emulation parameters that have values of zero, e.g., if a parameter update causes the parameter to change from a non-zero value to a value of zero. As another example, the compressed matrix representation 122 may represent brain emulation parameters that have values of zero during an evolutionary process of updating the compressed matrix representation. Example evolutionary processes are discussed in more detail below with reference to FIG. 2.

In this specification, a brain emulation parameter of a weight matrix that is explicitly identified by a compressed matrix representation of the weight matrix is called a “represented” brain emulation parameter. In this specification, a brain emulation parameter of a weight matrix that is not explicitly identified by a compressed matrix representation of the weight matrix is called an “unrepresented” brain emulation parameter.

For example, the compressed matrix representation 122 can include data identifying, for each represented brain emulation parameter, the value of the represented brain emulation parameter and the position of the represented brain emulation parameter in the weight matrix. The “position” of a brain emulation parameter in the weight matrix can be represented, e.g., by the row and column index of the brain emulation parameter in the weight matrix, e.g., as a tuple (i,j) where i represents the row index and j represents the column index.

A parameter data store 120 of the neural network computing system 100 can store the compressed matrix representation 122 of the weight matrix of the brain emulation neural network layer 108. When the brain emulation neural network 102 is processing a network input, the brain emulation neural network layer 108 can obtain the compressed matrix representation 122 of the weight matrix from the parameter data store 120 to generate the brain emulation layer output 112.

In some implementations, the brain emulation neural network layer 108 processes the compressed matrix representation 122 of the weight matrix to re-generate the full representation of the weight matrix, i.e., a representation in which all brain emulation parameters, including the unrepresented brain emulation parameters of the compressed matrix representation 122, are represented.

In some other implementations, the neural network computing system 100 uses a compressed matrix representation that is configured for efficient matrix multiplication. Thus, the brain emulation neural network layer 108 does not need to “decompress” the compressed matrix representation 122, but rather can apply the compressed matrix representation directly to the brain emulation layer input 110.

For example, the compressed matrix representation of a matrix can be configured to perform a matrix multiplication between the matrix and another tensor such that the unrepresented elements of the matrix are not explicitly multiplied against any values of the other tensor (as, in implementations in which the unrepresented elements all have value zero, the result of the multiplication is certain to also be zero). That is, a system executing a matrix multiplication using a compressed matrix representation of a matrix does not perform scalar multiplications of the unrepresented elements of the matrix.

For example, the compressed matrix representation 112 can be a COO matrix representation, where each represented brain emulation parameter is represented by a tuple that include the row of the parameter, the column of the parameter, and the value of the parameter. The COO matrix representation is highly efficient when used to execute matrix multiplications, and is supported by many machine learning computer-language libraries, e.g., TensorFlow.

In some implementations, the computational efficiency of executing a matrix multiplication using the compressed matrix representation 122 scales linearly or approximately linearly with the sparsity of the weight matrix of the brain emulation neural network layer 108. That is, if the weight matrix has a sparsity of 70%, then the neural network computing system can execute the matrix multiplication to generate the brain emulation layer output 112 using 70% fewer computations.

FIG. 2 shows an example neural network computing system 200. The neural network computing system 200 is an example of a system implemented as computer programs on one or more computers in one or more locations in which the systems, components, and techniques described below are implemented.

The neural network computing system 200 includes a neural network 202 that has (at least) three subnetworks: (i) a first trained subnetwork 204 (ii) a brain emulation subnetwork 208, and (iii) a second trained subnetwork 212. The neural network 202 is configured to process a network input 201 to generate a network output 214.

The first trained subnetwork 204 is configured to process the network input 201 in accordance with a set of model parameters 222 of the first trained subnetwork 204 to generate a first subnetwork output 206. The brain emulation subnetwork 208 is configured to process the first subnetwork output 206 in accordance with a set of model parameters 224 of the brain emulation subnetwork 208 to generate a brain emulation subnetwork output 210. The second trained subnetwork 212 is configured to process the brain emulation subnetwork output 210 in accordance with a set of model parameters 226 of the second trained subnetwork 212 to generate the network output 214.

The brain emulation subnetwork includes one or more brain emulation neural network layers whose respective architectures are represented by a weight matrix that is represented as a compressed matrix representation. For example, the brain emulation subnetwork 208 can be configured similarly to the brain emulation neural network 102 described above with reference to FIG. 1.

Although the neural network 202 depicted in FIG. 2 includes one trained subnetwork 204 before the brain emulation subnetwork 208 and one trained subnetwork 212 after the brain emulation subnetwork 208, in general the neural network 202 can include any number of trained subnetworks before and/or after the brain emulation subnetwork 208. In some implementations, the first trained subnetwork 204 and/or the second trained subnetwork 212 can include only one or a few neural network layers (e.g., a single fully-connected layer) that processes the respective subnetwork input to generate the respective subnetwork output.

In implementations where there are zero trained subnetworks before the brain emulation subnetwork 208, the brain emulation subnetwork 208 can receive the network input 201 directly as input. In implementations where there are zero trained subnetworks after the brain emulation subnetwork 208, the brain emulation subnetwork output 210 can be the network output 214.

Although the neural network 202 depicted in FIG. 2 includes a single brain emulation subnetwork 208, in general the neural network 202 can include multiple brain emulation subnetwork 208. In some implementations, each brain emulation subnetwork 208 has the same set of model parameters 224; in some other implementations, each brain emulation subnetwork 208 has a different set of model parameters 224. In some implementations, each brain emulation subnetwork 208 has the same network architecture; in some other implementations, each brain emulation subnetwork 208 has a different network architecture.

In some implementations, the neural network 202 is a recurrent neural network. In these implementations, the network input 201 includes a sequence of input elements. The first trained subnetwork 204 can process, at each of multiple time steps corresponding to respective input elements in the sequence, the input element to generate a respective first subnetwork output 206. At each time step, the brain emulation subnetwork 208 can process the first subnetwork output 206 to generate a respective brain emulation subnetwork output 210. At each time step, the second trained subnetwork 212 can process the brain emulation subnetwork output 210 to generate an output element corresponding to the input element.

At each time step, the neural network 202 can maintain a hidden state 220. That is, at each time step, the neural network 202 updates its hidden state 220; then, at the subsequent time step in the sequence of time steps, the neural network 202 receives as input (i) the input element of the network input 201 corresponding to the subsequent time step and (ii) the current hidden state 220.

In some implementations in which the neural network 202 is a recurrent neural network (e.g., in the example depicted in FIG. 2), the first trained subnetwork 204 receives both i) the input element of the sequence of the network input 201 and ii) the hidden state 220. For example, the recurrent neural network 202 can combine the input element and the hidden state 220 (e.g., through concatenation, addition, multiplication, or an exponential function) to generate a combined input, and then process the combined input using the first trained subnetwork 204.

In some implementations in which the neural network 202 is a recurrent neural network, the brain emulation subnetwork 208 receives as input the hidden state 220 and the first subnetwork output 206. For example, the neural network 202 can combine the first subnetwork output 206 and the hidden state 220 (e.g., through concatenation, addition, multiplication, or an exponential function) to generate a combined input, and then process the combined input using the brain emulation subnetwork 208.

In some implementations in which the neural network 202 is a recurrent neural network, the second trained subnetwork 212 receives as input the hidden state 220 and the brain emulation subnetwork output 210. For example, the neural network 202 can combine the brain emulation subnetwork output 210 and the hidden state 220 (e.g., through concatenation, addition, multiplication, or an exponential function) to generate a combined input, and then process the combined input using the second trained subnetwork 212.

In some implementations in which the neural network 202 is a recurrent neural network, the updated hidden state 220 generated at a time step is the same as the output element generated at the time step. In some other implementations, the hidden state 220 is an intermediate output of the neural network 202. An intermediate output refers to an output generated by a hidden artificial neuron or a hidden neural network layer of the neural network 202, i.e., an artificial neuron or neural network layer that is not included in the input layer or the output layer of the neural network 202. For example, the hidden state 220 can be the brain emulation subnetwork output 210. In some other implementations, the hidden state 220 is a combination of the output element and one or more intermediate outputs of the neural network 202. For example, the hidden state 220 can be computed using the output element and the brain emulation subnetwork output 210, e.g., by combining the two outputs and applying an activation function.

In some implementations in which the neural network 202 is a recurrent neural network, after each input element in the network input 201 has been processed by the recurrent neural network 202 to generate respective output elements, the recurrent neural network 202 can generate a network output 214 corresponding to the network input 201. In some such implementations, the network output 214 is the sequence of generated output elements. In some other implementations, the network output 214 is a subset of the generated output elements, e.g., the final output element corresponding to the final input element in the sequence of input elements of the network input 201. In some other implementations, the recurrent neural network 202 further processes the sequence of generated output elements to generate the network output 214. For example, the network output 214 can be the mean of the generated output elements.

In some implementations, the brain emulation subnetwork 208 itself has a recurrent neural network architecture. That is, the brain emulation subnetwork 208 can process the first subnetwork output 206 multiple times at respective sub-time steps (referred to as sub-time steps to differentiate from the time steps of the neural network 202 in implementations where the neural network 202 is a recurrent neural network).

For example, the architecture of the brain emulation subnetwork 208 can include a sequence of components (e.g., brain emulation neural network layers or groups of brain emulation neural network layers) such that the architecture includes a connection from each component in the sequence to the next component, and the first and last components of the sequence are identical. In one example, two brain emulation neural network layers that are each directly connected to one another (i.e., where the first layer provides its output the second layer, and the second layer provides its output to the first layer) would form a recurrent loop. A recurrent brain emulation subnetwork 208 can process the first subnetwork output 206 over multiple sub-time steps to generate a respective brain emulation subnetwork output 210 at each sub-time step. In particular, at each sub-time step, the brain emulation subnetwork 208 can process: (i) the first subnetwork output 206 (or a component of the first subnetwork output 206), and (ii) any outputs generated by the brain emulation subnetwork 208 at the preceding sub-time step, to generate the brain emulation subnetwork output 210 for the sub-time step. The neural network 202 can provide the brain emulation subnetwork output 210 generated by the brain emulation subnetwork 208 at the final sub-time step as the input to the second trained subnetwork 212. The number of sub-time steps over which the brain emulation subnetwork 208 processes a network input can be a predetermined hyper-parameter of the neural network computing system 200.

In some implementations, in addition to processing the brain emulation subnetwork output 210 generated by the output layer of the brain emulation subnetwork 208, the second trained subnetwork 212 can additionally process one or more intermediate outputs of the brain emulation subnetwork 208.

The neural network computing system 200 includes a training engine 216 that is configured to train the neural network 202.

In some implementations, the model parameters 224 for the brain emulation subnetwork 208 are untrained. Instead, the model parameters 224 of the brain emulation subnetwork 208 can be determined before the training of the trained subnetworks 204 and 212 based on the weight values of the edges in the synaptic connectivity graph. Optionally, the weight values of the edges in the synaptic connectivity graph can be transformed (e.g., by additive random noise) prior to being used for specifying model parameters 224 of the brain emulation subnetwork 208. This procedure enables the neural network 202 to take advantage of the information from the synaptic connectivity graph encoded into the brain emulation subnetwork 208 in performing prediction tasks.

Therefore, rather than training the entire neural network 202 from end-to-end, the training engine 216 can train only the model parameters 222 of the first trained subnetwork 204 and the model parameters 226 of the second trained subnetwork 212, while leaving the model parameters 224 of the brain emulation subnetwork 208 fixed during training.

The training engine 216 can train the neural network 202 on a set of training data over multiple training iterations. The training data can include a set of training examples, where each training example specifies: (i) a training network input, and (ii) a target network output that should be generated by the neural network 202 by processing the training network input.

At each training iteration, the training engine 216 can sample a batch of training examples from the training data, and process the training inputs specified by the training examples using the neural network 202 to generate corresponding network outputs 214. In particular, for each training input, the neural network 202 processes the training input using the current model parameter values 222 of the first trained subnetwork 204 to generate a first subnetwork output 206. The neural network 202 processes the first subnetwork output 206 in accordance with the static model parameter values 224 of the brain emulation subnetwork 208 to generate a brain emulation subnetwork output 210. The neural network 202 then processes the brain emulation subnetwork output 210 using the current model parameter values 226 of the second trained subnetwork 212 to generate the network output 214 corresponding to the training input.

The training engine 216 adjusts the model parameters values 222 of the first trained subnetwork 204 and the model parameter values 226 of the second trained subnetwork 212 to optimize an objective function that measures a similarity between: (i) the network outputs 214 generated by the neural network 202, and (ii) the target network outputs specified by the training examples. The objective function can be, e.g., a cross-entropy objective function, a squared-error objective function, or any other appropriate objective function.

To optimize the objective function, the training engine 216 can determine gradients of the objective function with respect to the model parameters 222 of the first trained subnetwork 204 and the model parameters 226 of the second trained subnetwork 212, e.g., using backpropagation techniques. The training engine 216 can then use the gradients to adjust the model parameter values 222 and 226, e.g., using any appropriate gradient descent optimization technique, e.g., an RMSprop or Adam gradient descent optimization technique.

The training engine 216 can use any of a variety of regularization techniques during training of the neural network 202. For example, the training engine 216 can use a dropout regularization technique, such that certain artificial neurons of the neural network 202 are “dropped out” (e.g., by having their output set to zero) with a non-zero probability p>0 each time the neural network 202 processes a network input. Using the dropout regularization technique can improve the performance of the trained neural network 202, e.g., by reducing the likelihood of over-fitting. As another example, the training engine 216 can regularize the training of the neural network 202 by including a “penalty” term in the objective function that measures the magnitude of the model parameter values 222 and 226 of the trained subnetworks 204 and 212. The penalty term can be, e.g., an L₁ or L₂ norm of the model parameter values 222 of the first trained subnetwork 204 and/or the model parameter values 226 of the second trained subnetwork 212. In some other implementations, the model parameters 224 for the brain emulation subnetwork 208 are trained. That is, after initial values for the model parameters 224 of the brain emulation subnetwork 208 have been determined based on the weight values of the edges in the synaptic connectivity graph, the training engine 216 can update the weights of the model parameters, as described above with reference to the parameters 222 and 226 of the trained subnetworks, e.g., using backpropagation and stochastic gradient descent.

Because the weight matrices of the brain emulation neural network layers of the brain emulation subnetwork 208 using the compressed matrix representation, the training engine 216 can efficiently update the represented brain emulation parameters of the weight matrices while keeping the unrepresented brain emulation parameters of the weight matrices constant, i.e., at zero. That is, if the weight matrices were represented fully and the training engine 216 executed backpropagation and gradient descent across all the values of the weight matrices, unrepresented brain emulation parameters having value zero would likely be updated to non-zero values. Because the weight matrices represent synaptic connectivity between neurons in the brain of a biological organism, updating a unrepresented, zero-value brain emulation parameter to have a non-zero value corresponds to incorrectly representing synaptic connectivity between the pair of neurons represented by the brain emulation parameter, when no such synaptic connectivity was measured in the brain of the biological organism. Thus, in some implementations in which fidelity to the measured synaptic connectivity is important, representing the weight matrices using the compressed matrix representation allows the training engine 216 to efficiently update the weight matrices of the brain emulation subnetwork 208 without inserting representations of new and incorrect synaptic connections.

In some implementations, the training engine 216 does update which brain emulation parameters of the weight matrices are represented and which brain emulation parameters are unrepresented. That is, during training of the neural network 202, the training engine 216 can update the compressed matrix representations of the weight matrices such that brain emulation parameters are added to the compressed matrix representations (e.g., corresponding to changing a zero-value brain emulation parameter to a non-zero brain emulation parameter) and some brain emulation parameters are removed from the compressed matrix representation (e.g., corresponding to changing a non-zero brain emulation parameter to a zero-value brain emulation parameter).

In particular, for one or more weight matrices of respective brain emulation neural network layers, the training engine 216 can execute an artificial evolutionary procedure whereby, over multiple training stages, the training engine 216 iteratively removes the brain emulation parameters representing the weakest synaptic connections in the brain of the biological organism from the compressed matrix representation of the weight matrix. The training engine 216 can also add new brain emulation parameters to the compressed matrix representation of the weight matrix, where the new brain emulation parameters represent “new” synaptic connections in the brain of the biological organism (i.e., synaptic connections that were not measured in the brain of the biological organism).

This procedure is referred to as “evolutionary” because it simulates, across the multiple training stages, the removal of “weak” brain emulation parameters (e.g., brain emulation parameters with the lowest value or magnitude) and the addition of new brain emulation parameters that may improve the performance of the neural network 202. Performing the evolutionary procedure can further reduce the amount of training data and the number of training iterations required to train the neural network 202 to achieve an acceptable level of performance, e.g., as measured by prediction accuracy.

For example, at each of one or more training stages during the training of the neural network 202 and for each of one or more weight matrices of the brain emulation subnetwork 208, the training engine 216 can stochastically sample (i.e., select) represented brain emulation parameters of the compressed matrix representation of the weight matrix, and remove the sampled represented brain emulation parameters from the compressed matrix representation.

As a particular example, the training engine 216 can sample each represented brain emulation parameter with a uniform likelihood. That is, each represented brain emulation parameter can have the same likelihood of being selected, regardless of the value of the parameter of the position of the parameter within the compressed matrix representation. As another particular example, the training engine 216 can determine the N represented brain emulation parameters that have the lowest respective magnitudes, N>1, and sample the N represented brain emulation parameters uniformly. For instance, N can be a predetermined integer, or N can be a predetermined fraction of the total number of represented brain emulation parameters in the compressed matrix representation.

As another particular example, the training engine 216 can sample each represented brain emulation parameter with a likelihood that is inversely proportional with the magnitude of its value. That is, represented brain emulation parameters with lower magnitudes can be more likely to be selected than represented brain emulation parameters with higher magnitudes.

In some such implementations, the training engine 216 can determine the likelihood of sampling each represented brain emulation parameter to be equal to the softmax of the negated magnitude of the represented brain emulation parameter. That is, the training engine 216 can compute:

$${p}_{i} = \frac{{e}^{- \vert {x}_{i} \vert}}{{Σ}_{j} {e}^{- \vert {x}_{j} \vert}}$$

where xᵢ is the value of the i^{th} represented brain emulation parameter and pᵢ is the likelihood with which the i^{th} represented brain emulation parameter is sampled by the training engine 216.

In some other such implementations, the training engine 216 can determine the likelihood of sampling each represented brain emulation parameter to be equal to the softmax of the inverse magnitude of the represented brain emulation parameter. That is, the training engine 216 can compute:

$${p}_{i} = \frac{{e}^{1 / \vert {x}_{i} \vert}}{{Σ}_{j} {e}^{1 / \vert {x}_{j} \vert}}$$

In some other such implementations, the training engine 216 can determine the N represented brain emulation parameters that have the lowest respective magnitudes, N>1, and sample the N represented brain emulation parameters according to either of the softmax equations described above.

As another particular example, the training engine 216 can sample each represented brain emulation parameter with a likelihood that is inversely proportional to the rank of the represented brain emulation parameter in a ranking of the represented brain emulation parameters of the weight matrix. That is, represented brain emulation parameters with lower ranks in the ranking of the magnitudes can be more likely to be selected than represented brain parameters with higher ranks in the ranking of the magnitudes. In some such implementations, the training engine 216 can determine the N represented brain emulation parameters that have the lowest respective ranks in the ranking of the magnitudes, N>1, and sample the N represented brain emulation parameters according to their respective ranks.

As another example, the training engine 216 can execute a two-step process for stochastically sampling the represented brain emulation parameters of the compressed matrix representation. In the first step of the two-step process, the training engine 216 can generate a set of candidate represented brain emulation parameters by sampling the represented brain emulation parameters according to a ranking of their magnitudes. In the second step of the two-step process, the training engine 216 can sample from the set of represented brain emulation parameters according to their magnitudes (e.g., using a softmax function as described above). The training engine 216 can then remove the candidate represented brain emulation parameters samples in the second step from the compressed matrix representation.

In some implementations, the training engine 216 removes the same number of represented brain emulation parameters at each training stage. In some other implementations, the training engine 216 can sample a different number of represented brain emulation parameters at each training stage.

Instead of or in addition to removing represented brain emulation parameters from the compressed matrix representation, the training engine 216 can add “new” represented brain emulation parameters to the compressed matrix representation at each of one or more training stages. For example, training engine 216 can randomly sample one or more unrepresented brain emulation parameters of the compressed matrix representation, generate values for the sampled unrepresented brain emulation parameters, and insert the sampled unrepresented brain emulation parameters, having the respective generated values, into the compressed matrix representation as newly-represented brain emulation parameters.

For example, the training engine 216 can sample a respective value for each new represented brain emulation parameter from a predefined distribution, e.g., a uniform distribution between 0 and 1 or a Normal distribution with mean 0.

As another example, the training engine 216 can determine the initial value of the new represented brain emulation parameters to be 0. As described above, in some cases, a brain emulation parameter can have a value of zero and still be explicitly represented in the compressed matrix representation. So, the training engine 216 can explicitly add a representation of the previously-unrepresented brain emulation parameters to the compressed matrix representation, and set their values to be zero. Then, during training of the neural network 202, the value of these new non-zero brain emulation parameters can be updated to have non-zero values, e.g., using stochastic gradient descent.

In some implementations, the training engine 216 samples the same number of unrepresented brain emulation parameters as the number of represented value brain emulation parameters sampled as described above. That is, the compressed matrix representation can include the same number of represented brain emulation parameters before and after the training stage. In some other implementations, the training engine 216 samples a different number of represented and unrepresented brain emulation parameters during a given training stage, such that the number of represented brain emulation parameters in the compressed matrix representation changes.

In some implementations, the training engine 216 can sample new represented brain emulation parameters to add to the compressed matrix representation such that the sampled new represented brain emulation parameters are biologically plausible. That is, the training engine 216 can ensure that each new represented brain emulation parameter represents a pair of neurons that could plausibly share a synaptic connection in the brain of the biological organism. For example, the training engine 216 can sample represented brain emulation parameters corresponding to pairs of neurons in the same region of the brain of the biological organism.

The neural network 202 can be configured to perform any appropriate task. A few examples follow.

In one example, the neural network 202 can be configured to process network inputs 201 that represent sequences of audio data. For example, each input element in the network input 201 can be a raw audio sample or an input generated from a raw audio sample (e.g., a spectrogram), and the neural network 202 can process the sequence of input elements to generate network outputs 214 representing predicted text samples that correspond to the audio samples. That is, the neural network 202 can be a “speech-to-text” neural network. As another example, each input element can be a raw audio sample or an input generated from a raw audio sample, and the neural network 202 can generate a predicted class of the audio samples, e.g., a predicted identification of a speaker corresponding to the audio samples. As a particular example, the predicted class of the audio sample can represent a prediction of whether the input audio example is a verbalization of a predefined work or phrase, e.g., a “wakeup” phrase of a mobile device. In some implementations, one or more weight matrices of the brain emulation subnetwork 208 can be generated from a subgraph of the synaptic connectivity graph corresponding to an audio region of the brain, i.e., a region of the brain that processes auditory information (e.g., the auditory cortex).

In another example, the neural network 202 can be configured to process network inputs 201 that represent sequences of text data. For example, each input element in the network input 201 can be a text sample (e.g., a character, phoneme, or word) or an embedding of a text sample, and the neural network 202 can process the sequence of input elements to generate network outputs 214 representing predicted audio samples that correspond to the text samples. That is, the neural network 202 can be a “text-to-speech” neural network. As another example, each input element can be an input text sample or an embedding of an input text sample, and the neural network 202 can generate a network output 214 representing a sequence of output text samples corresponding to the sequences of input text samples. As a particular example, the output text samples can represent the same text as the input text samples in a different language (i.e., the neural network 202 can be a machine translation neural network). As another particular example, the output text samples can represent an answer to a question posed by the input text samples (i.e., the neural network 202 can be a question-answering neural network). As another example, the input text samples can represent two texts (e.g., as separated by a delimiter token), and the neural network 202 can generate a network output representing a predicted similarity between the two texts. In some implementations, one or more weight matrices of the brain emulation subnetwork 208 can be generated from a subgraph of the synaptic connectivity graph corresponding to a speech region of the brain, i.e., a region of the brain that is linked to speech production (e.g., Broca's area).

In another example, the neural network 202 can be configured to process network inputs 201 representing one or more images, e.g., sequences of video frames. For example, each input element in the network input 201 can be a video frame or an embedding of a video frame, and the neural network 202 can process the sequence of input elements to generate a network output 214 representing a prediction about the video represented by the sequence of video frames. As a particular example, the neural network 202 can be configured to track a particular object in each of the frames of the video, i.e., to generate a network output 214 that includes a sequences of output elements, where each output elements represents a predicted location within a respective video frames of the particular object. In some implementations, the brain emulation subnetwork 208 can be generated from a subgraph of the synaptic connectivity graph corresponding to a visual region of the brain, i.e., a region of the brain that processes visual information (e.g., the visual cortex).

In another example, the neural network 202 can be configured to process a network input 201 representing a respective current state of an environment at each of one or more time points, and to generate a network output 214 representing action selection outputs that can be used to select actions to be performed at respective time points by an agent interacting with the environment. For example, each action selection output can specify a respective score for each action in a set of possible actions that can be performed by the agent, and the agent can select the action to be performed by sampling an action in accordance with the action scores. In one example, the agent can be a mechanical agent interacting with a real-world environment to perform a navigation task (e.g., reaching a goal location in the environment), and the actions performed by the agent cause the agent to navigate through the environment.

In this specification, an embedding is an ordered collection of numeric values that represents an input in a particular embedding space. For example, an embedding can be a vector of floating point or other numeric values that has a fixed dimensionality.

After training, the neural network 202 can be directly applied to perform prediction tasks. For example, the neural network 202 can be deployed onto a user device. In some implementations, the neural network 202 can be deployed directly into resource-constrained environments (e.g., mobile devices). Neural networks 202 that include brain emulation subnetworks 208 can generally perform at a high level, e.g., in terms of prediction accuracy, even with very few model parameters compared to other neural networks. For example, neural networks 202 as described in this specification that have, e.g., 100 or 1000 model parameters can achieve comparable performance to other neural networks that have millions of model parameters. Thus, the neural network 202 can be implemented efficiently and with low latency on user devices.

In some implementations, after the neural network 202 has been deployed onto a user device, some of the parameters of the neural network 202 can be further trained, i.e., “fine-tuned,” using new training example obtained by the user device. For example, some of the parameters can be fine-tuned using training example corresponding to the specific user of the user device, so that the neural network 202 can achieve a higher accuracy for inputs provided by the specific user. As a particular example, the model parameters 222 of the first trained subnetwork 204 and/or the model parameters 226 of the second trained subnetwork 212 can be fine-tuned on the user device using new training examples while the model parameters 224 of the brain emulation subnetwork 208 are held static, as described above.

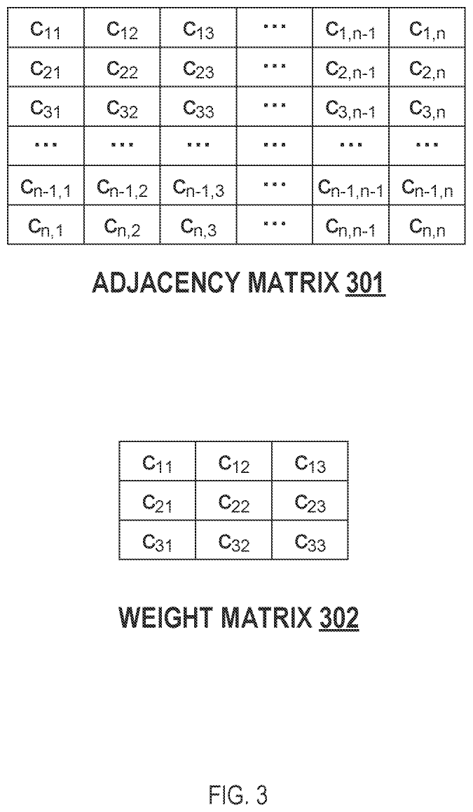

FIG. 3 illustrates an example weight matrix 302 of a brain emulation neural network layer determined using synaptic connectivity

As described in more detail below with reference to FIG. 4B, a system (e.g., the graphing system 412 depicted in FIG. 4B), can generate a synaptic connectivity graph that represents the synaptic connectivity between neurons in the brain of the biological organism. The synaptic connectivity graph can be represented using an adjacency matrix 301, all of which or a portion of which can be used as the weight matrix 302 of the brain emulation neural network layer.

As illustrated in FIG. 3, the adjacency matrix 301 includes n² elements, where n is the number of neurons drawn from the brain of the biological organism. For example, the adjacency matrix 301 can include hundreds, thousands, tens of thousands, hundreds of thousands, millions, tens of millions, or hundreds of millions of elements.

Each element of the adjacency matrix 301 represents the synaptic connectivity between a respective pair of neurons in the set of n neurons. That is, each element c_{i,j} identifies the synaptic connection between neuron i and neuron j. As described in more detail below, in some implementations, each of the elements c_{i,j} are either zero (representing that there is no synaptic connection between the corresponding neurons) or one (representing that there is a synaptic connection between the corresponding neurons), while in some other implementations, each element c_{i,j} is a scalar value representing the strength of the synaptic connection between the corresponding neurons.

As described above with reference to FIG. 1, each row of the adjacency matrix 301 can represent a respective neuron in a first set of neurons of the brain of the biological organism, and each column of the adjacency matrix 301 can represent a respective neuron in a second set of neurons of the brain of the biological organism. Generally, the first set and the second set can be overlapping or disjoint. As a particular example, the first set and the second set can be the same.

In some implementations (e.g., in implementations in which the synaptic connectivity graph is undirected), the adjacency matrix 301 is symmetric (i.e., each element c_{i,j} is the same as element while in some other implementations (e.g., in implementations in which the synaptic connectivity graph is directed), the adjacency matrix 301 is not symmetric (i.e., there may exist elements c_{i,j} and c_{j,i} such that c_{i,j}≠c_{j,i}).

Although the above description refers to neurons in the brain of the biological organism, generally the elements of the adjacency matrix can correspond to pairs of any appropriate component of the brain of the biological organism. For example, each element can correspond to a pair of voxels in a voxel grid of the brain of the biological organism. As another example, each element can correspond to a pair of sub-neurons of the brain of the biological organism. As another example, each element can correspond to a pair of sets of multiple neurons of the brain of the biological organism.

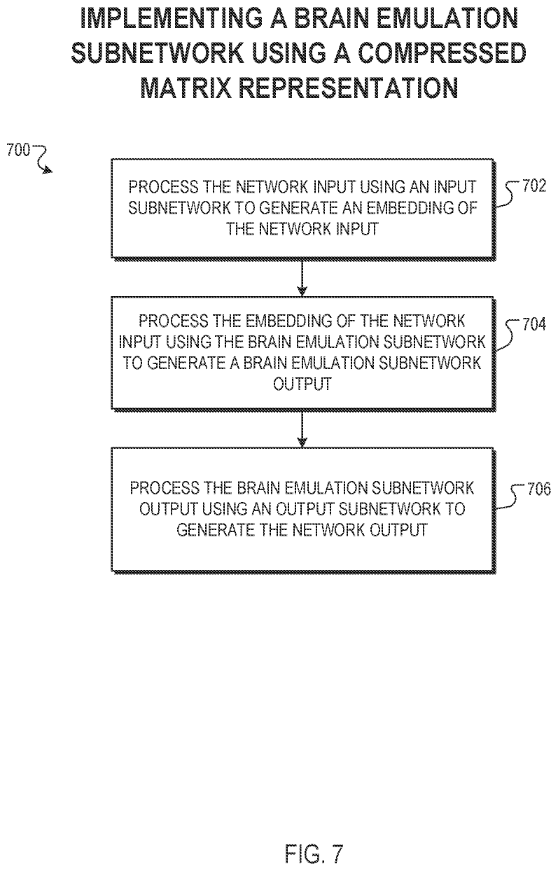

As described in more detail below with reference to FIG. 4B, an architecture mapping system (e.g., the architecture mapping system 420 depicted in FIG. 4B) can generate the weight matrix 302 from the adjacency matrix 301. Generally, the elements of the weight matrix 302 (i.e., the brain emulation parameters of the brain emulation neural network layer) are a subset of the elements of the adjacency matrix 301. For example, as depicted in FIG. 3, the weight matrix 302 includes the elements of the adjacency matrix 301 representing neuronal connections between the neurons represented by the first three rows and first three columns of the adjacency matrix 301. For example, the weight matrix 302 can represent only neurons of a particular type in the brain of the biological organism. Identifying neurons of a particular type is discussed in more detail below with reference to FIG. 7.

For convenience, the weight matrix 302 is illustrated as including only nine brain emulation parameters; generally, weight matrices of brain emulation neural network layers can have significantly more brain emulation parameters, e.g., hundreds, thousands, or millions of brain emulation parameters. Although the weight matrix 302 is depicted as square in FIG. 3 (i.e., the same number of columns and rows), generally the weight matrix 302 can have any appropriate dimensionality.

The weight matrix can be a sparse matrix, i.e., can include more than a threshold number or proportion of zero-value brain emulation parameters. The weight matrix can thus be represented using a compressed matrix representation, as described above.

In some implementations, the weight matrix 302 represents the entire synaptic connectivity graph. That is, the weight matrix 302 can include a respective row and column for each node of the synaptic connectivity graph. Because the weight matrix 302 will be represented using the compressed matrix representation when applied by the brain emulation neural network layer, representing the entire synaptic connectivity graph is significantly more feasible and efficient than if the weight matrix 302 were represented fully. Thus, in memory-constrained or computationally-constrained environments, leveraging the compressed matrix representation can allow systems to represent the full brain of the biological organism in implementations in which doing so would otherwise be prohibitive.

FIG. 4A illustrates an example of generating an artificial (i.e., computer implemented) brain emulation neural network 409 based on a synaptic resolution image 405 of the brain 403 of a biological organism 401, e.g., a fly. The synaptic resolution image 405 can be processed to generate a synaptic connectivity graph 407, e.g., where each node of the graph 407 corresponds to a neuron in the brain 403, and two nodes in the graph 407 are connected if the corresponding neurons in the brain 403 share a synaptic connection. The structure of the graph 407 can be used to specify the architecture of the brain emulation neural network 409. For example, each node of the graph 407 can mapped to an artificial neuron, a neural network layer, or a group of neural network layers in the brain emulation neural network 409. Further, each edge of the graph 407 can be mapped to a connection between artificial neurons, layers, or groups of layers in the brain emulation neural network 409. The brain 403 of the biological organism 401 can be adapted by evolutionary pressures to be effective at solving certain tasks, e.g., classifying objects or generating robust object representations, and the brain emulation neural network 409 can share this capacity to effectively solve tasks.

FIG. 4B shows an example data flow 400 for generating a synaptic connectivity graph 402 and a brain emulation neural network 404 based on the brain 406 of a biological organism.

As used throughout this document, a brain may refer to any amount of nervous tissue from a nervous system of a biological organism, and nervous tissue may refer to any tissue that includes neurons (i.e., nerve cells). The biological organism can be, e.g., a worm, a fly, a mouse, a cat, or a human.

An imaging system 408 can be used to generate a synaptic resolution image 410 of the brain 406. An image of the brain 406 may be referred to as having synaptic resolution if it has a spatial resolution that is sufficiently high to enable the identification of at least some synapses in the brain 406. Put another way, an image of the brain 406 may be referred to as having synaptic resolution if it depicts the brain 406 at a magnification level that is sufficiently high to enable the identification of at least some synapses in the brain 406. The image 410 can be a volumetric image, i.e., that characterizes a three-dimensional representation of the brain 406. The image 410 can be represented in any appropriate format, e.g., as a three-dimensional array of numerical values.

The imaging system 408 can be any appropriate system capable of generating synaptic resolution images, e.g., an electron microscopy system. The imaging system 408 can process “thin sections” from the brain 406 (i.e., thin slices of the brain attached to slides) to generate output images that each have a field of view corresponding to a proper subset of a thin section. The imaging system 408 can generate a complete image of each thin section by stitching together the images corresponding to different fields of view of the thin section using any appropriate image stitching technique. The imaging system 408 can generate the volumetric image 410 of the brain by registering and stacking the images of each thin section. Registering two images refers to applying transformation operations (e.g., translation or rotation operations) to one or both of the images to align them. Example techniques for generating a synaptic resolution image of a brain are described with reference to: Z. Zheng, et al., “A complete electron microscopy volume of the brain of adult Drosophila melanogaster,” Cell 174, 730-743 (2018).

A graphing system 412 is configured to process the synaptic resolution image 410 to generate the synaptic connectivity graph 402. The synaptic connectivity graph 402 specifies a set of nodes and a set of edges, such that each edge connects two nodes. To generate the graph 402, the graphing system 412 identifies each neuron in the image 410 as a respective node in the graph, and identifies each synaptic connection between a pair of neurons in the image 410 as an edge between the corresponding pair of nodes in the graph.

The graphing system 412 can identify the neurons and the synapses depicted in the image 410 using any of a variety of techniques. For example, the graphing system 412 can process the image 410 to identify the positions of the neurons depicted in the image 410, and determine whether a synapse connects two neurons based on the proximity of the neurons (as will be described in more detail below). In this example, the graphing system 412 can process an input including: (i) the image, (ii) features derived from the image, or (iii) both, using a machine learning model that is trained using supervised learning techniques to identify neurons in images. The machine learning model can be, e.g., a convolutional neural network model or a random forest model. The output of the machine learning model can include a neuron probability map that specifies a respective probability that each voxel in the image is included in a neuron. The graphing system 412 can identify contiguous clusters of voxels in the neuron probability map as being neurons.

Optionally, prior to identifying the neurons from the neuron probability map, the graphing system 412 can apply one or more filtering operations to the neuron probability map, e.g., with a Gaussian filtering kernel. Filtering the neuron probability map can reduce the amount of “noise” in the neuron probability map, e.g., where only a single voxel in a region is associated with a high likelihood of being a neuron.

The machine learning model used by the graphing system 412 to generate the neuron probability map can be trained using supervised learning training techniques on a set of training data. The training data can include a set of training examples, where each training example specifies: (i) a training input that can be processed by the machine learning model, and (ii) a target output that should be generated by the machine learning model by processing the training input. For example, the training input can be a synaptic resolution image of a brain, and the target output can be a “label map” that specifies a label for each voxel of the image indicating whether the voxel is included in a neuron. The target outputs of the training examples can be generated by manual annotation, e.g., where a person manually specifies which voxels of a training input are included in neurons.

Example techniques for identifying the positions of neurons depicted in the image 410 using neural networks (in particular, flood-filling neural networks) are described with reference to: P. H. Li et al.: “Automated Reconstruction of a Serial-Section EM Drosophila Brain with Flood-Filling Networks and Local Realignment,” bioRxiv doi:10.1101/605634 (2019).

The graphing system 412 can identify the synapses connecting the neurons in the image 410 based on the proximity of the neurons. For example, the graphing system 412 can determine that a first neuron is connected by a synapse to a second neuron based on the area of overlap between: (i) a tolerance region in the image around the first neuron, and (ii) a tolerance region in the image around the second neuron. That is, the graphing system 412 can determine whether the first neuron and the second neuron are connected based on the number of spatial locations (e.g., voxels) that are included in both: (i) the tolerance region around the first neuron, and (ii) the tolerance region around the second neuron. For example, the graphing system 412 can determine that two neurons are connected if the overlap between the tolerance regions around the respective neurons includes at least a predefined number of spatial locations (e.g., one spatial location). A “tolerance region” around a neuron refers to a contiguous region of the image that includes the neuron. For example, the tolerance region around a neuron can be specified as the set of spatial locations in the image that are either: (i) in the interior of the neuron, or (ii) within a predefined distance of the interior of the neuron.

The graphing system 412 can further identify a weight value associated with each edge in the graph 402. For example, the graphing system 412 can identify a weight for an edge connecting two nodes in the graph 402 based on the area of overlap between the tolerance regions around the respective neurons corresponding to the nodes in the image 410 (e.g., based on a proximity of the respective neurons). The area of overlap can be measured, e.g., as the number of voxels in the image 410 that are contained in the overlap of the respective tolerance regions around the neurons. The weight for an edge connecting two nodes in the graph 402 may be understood as characterizing the (approximate) strength of the connection between the corresponding neurons in the brain (e.g., the amount of information flow through the synapse connecting the two neurons).

In addition to identifying synapses in the image 410, the graphing system 412 can further determine the direction of each synapse using any appropriate technique. The “direction” of a synapse between two neurons refers to the direction of information flow between the two neurons, e.g., if a first neuron uses a synapse to transmit signals to a second neuron, then the direction of the synapse would point from the first neuron to the second neuron. Example techniques for determining the directions of synapses connecting pairs of neurons are described with reference to: C. Seguin, A. Razi, and A. Zalesky: “Inferring neural signaling directionality from undirected structure connectomes,” Nature Communications 10, 4289 (2019), doi:10.1038/s41467-019-12201-w.

In implementations where the graphing system 412 determines the directions of the synapses in the image 410, the graphing system 412 can associate each edge in the graph 402 with the direction of the corresponding synapse. That is, the graph 402 can be a directed graph. In some other implementations, the graph 402 can be an undirected graph, i.e., where the edges in the graph are not associated with a direction.

The graph 402 can be represented in any of a variety of ways. For example, the graph 402 can be represented as a two-dimensional array of numerical values with a number of rows and columns equal to the number of nodes in the graph. The component of the array at position (i,j) can have value 1 if the graph includes an edge pointing from node i to node j, and value 0 otherwise. In implementations where the graphing system 412 determines a weight value for each edge in the graph 402, the weight values can be similarly represented as a two-dimensional array of numerical values. More specifically, if the graph includes an edge connecting node i to node j, the component of the array at position (i,j) can have a value given by the corresponding edge weight, and otherwise the component of the array at position (i,j) can have value 0.

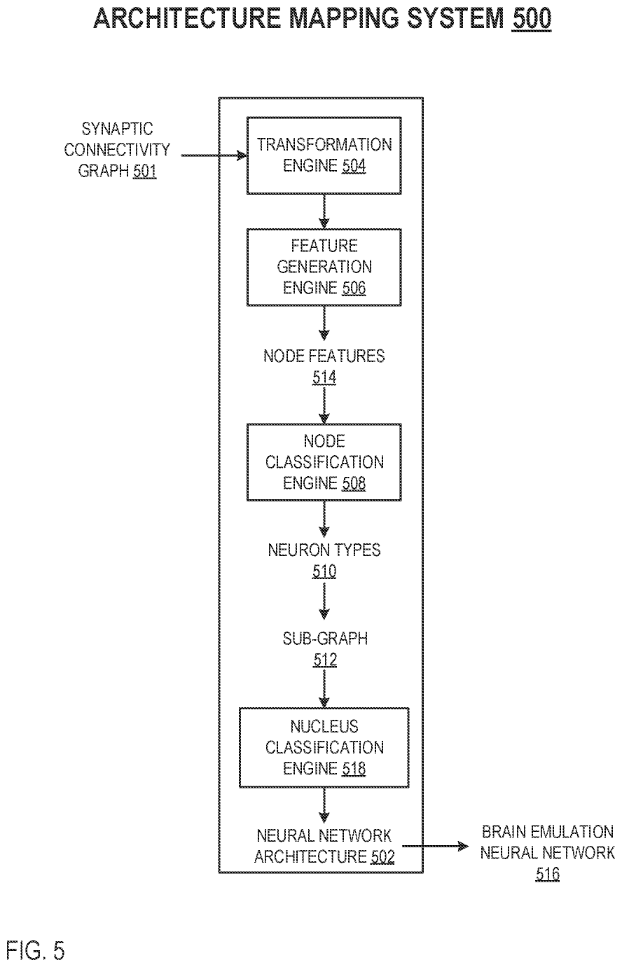

An architecture mapping system 420 can process the synaptic connectivity graph 402 to determine the architecture of the brain emulation neural network 404. For example, the architecture mapping system 420 can map each node in the graph 402 to: (i) an artificial neuron, (ii) a neural network layer, or (iii) a group of neural network layers, in the architecture of the brain emulation neural network 404. The architecture mapping system 420 can further map each edge of the graph 402 to a connection in the brain emulation neural network 404, e.g., such that a first artificial neuron that is connected to a second artificial neuron is configured to provide its output to the second artificial neuron. In some implementations, the architecture mapping system 420 can apply one or more transformation operations to the graph 402 before mapping the nodes and edges of the graph 402 to corresponding components in the architecture of the brain emulation neural network 404, as will be described in more detail below. An example architecture mapping system is described in more detail below with reference to FIG. 5.

The brain emulation neural network 404 can be provided to a training system 414 that trains the brain emulation neural network using machine learning techniques, i.e., generates an update to the respective values of one or more parameters of the brain emulation neural network.

In some implementations, the training system 414 is a supervised training system that is configured to train the brain emulation neural network 404 using a set of training data. The training data can include multiple training examples, where each training example specifies: (i) a training input, and (ii) a corresponding target output that should be generated by the brain emulation neural network 404 by processing the training input. In one example, the direct training system 414 can train the brain emulation neural network 404 over multiple training iterations using a gradient descent optimization technique, e.g., stochastic gradient descent. In this example, at each training iteration, the direct training system 414 can sample a “batch” (set) of one or more training examples from the training data, and process the training inputs specified by the training examples to generate corresponding network outputs. The direct training system 414 can evaluate an objective function that measures a similarity between: (i) the target outputs specified by the training examples, and (ii) the network outputs generated by the brain emulation neural network, e.g., a cross-entropy or squared-error objective function. The direct training system 414 can determine gradients of the objective function, e.g., using backpropagation techniques, and update the parameter values of the brain emulation neural network 404 using the gradients, e.g., using any appropriate gradient descent optimization algorithm, e.g., RMSprop or Adam.

In some other implementations, the training system 414 is an adversarial training system that is configured to train the brain emulation neural network 404 in an adversarial fashion. For example, the training system 414 can include a discriminator neural network that is configured to process network outputs generated by the brain emulation neural network 404 to generate a prediction of whether the network outputs are “real” outputs (i.e., outputs that were not generated by the brain emulation neural network, e.g., outputs that represent data that was captured from the real world) or “synthetic” outputs (i.e., outputs generated by the brain emulation neural network 404). The training system can then determine an update to the parameters of the brain emulation neural network in order to increase an error in the prediction of the discriminator neural network; that is, the goal of the brain emulation neural network is to generate synthetic outputs that are realistic enough that the discriminator neural network predicts them to be real outputs. In some implementations, concurrently with training the brain emulation neural network 404, the training system 414 generates updates to the parameters of the discriminator neural network.

In some other implementations, the training system 414 is a distillation training system that is configured to use the brain emulation neural network 404 to facilitate training of a “student” neural network having a less complex architecture than the brain emulation neural network 404. The complexity of a neural network architecture can be measured, e.g., by the number of parameters required to specify the operations performed by the neural network. The training system 414 can train the student neural network to match the outputs generated by the brain emulation neural network. After training, the student neural network can inherit the capacity of the brain emulation neural network 404 to effectively solve certain tasks, while consuming fewer computational resources (e.g., memory and computing power) than the brain emulation neural network 404. Typically, the training system 414 does not update the parameters of the brain emulation neural network 404 while training the student neural network. That is, in these implementations, the training system 414 is configured to train the student neural network instead of the brain emulation neural network 404.

As a particular example, the training system 414 can be a distillation training system that trains the student neural network in an adversarial manner. For example, the training system 414 can include a discriminator neural network that is configured to process network outputs that were generated either by the brain emulation neural network 404 or the student neural network, and to generate a prediction of whether the network outputs where generated by the brain emulation neural network 404 or the student neural network. The training system can then determine an update to the parameters of the student neural network in order to increase an error in the prediction of the discriminator neural network; that is, the goal of the student neural network is to generate network outputs that resemble network outputs generated by the brain emulation neural network 402 so that the discriminator neural network predicts that they were generated by the brain emulation neural network 404.

In some implementations, the brain emulation neural network 404 is a subnetwork of a neural network that includes one or more other neural network layers, e.g., one or more other subnetworks.

For example, the brain emulation neural network 404 can be a subnetwork of a “reservoir computing” neural network. The reservoir computing neural network can include i) the brain emulation neural network, which includes untrained parameters, and ii) one or more other subnetworks that include trained parameters. For example, the reservoir computing neural network can be configured to process a network input using the brain emulation neural network 404 to generate an alternative representation of the network input, and process the alternative representation of the network input using a “prediction” subnetwork to generate a network output.

During training of the reservoir computing neural network, the parameter values of the one or more other subnetworks (e.g., the prediction subnetwork) are trained, but the parameter values of the brain emulation neural network 404 are static, i.e., are not trained. Instead of being trained, the parameter values of the brain emulation neural network 404 can be determined from the weight values of the edges of the synaptic connectivity graph, as will be described in more detail below. The reservoir computing neural network facilitates application of the brain emulation neural network to machine learning tasks by obviating the need to train the parameter values of the brain emulation neural network 404.

After the training system 414 has completed training the brain emulation neural network 404 (or a neural network that includes the brain emulation neural network as a subnetwork, or a student neural network trained using the brain emulation neural network), the brain emulation neural network 404 can be deployed by a deployment system 422. That is, the operations of the brain emulation neural network 404 can be implemented on a device or a system of devices for performing inference, i.e., receiving network inputs and processing the network inputs to generate network outputs. In some implementations, the brain emulation neural network 404 can be deployed onto a cloud system, i.e., a distributed computing system having multiple computing nodes, e.g., hundreds or thousands of computing nodes, in one or more locations. In some other implementations, the brain emulation neural network 404 can be deployed onto a user device.

For example, the brain emulation neural network 404 (or a neural network that includes the brain emulation neural network as a subnetwork, or a student neural network that has been trained using the brain emulation neural network) can be deployed as a recurrent neural network that is configured to process a sequence of network inputs, as described above.

FIG. 5 shows an example architecture mapping system 500. The architecture mapping system 500 is an example of a system implemented as computer programs on one or more computers in one or more locations in which the systems, components, and techniques described below are implemented.

The architecture mapping system 500 is configured to process a synaptic connectivity graph 501 (e.g., the synaptic connectivity graph 402 depicted in FIG. 4B) to determine a corresponding neural network architecture 502 of a brain emulation neural network 516 (e.g., the brain emulation neural network 404 depicted in FIG. 4B). The architecture mapping system 500 can determine the architecture 502 using one or more of: a transformation engine 504, a feature generation engine 506, a node classification engine 508, and a nucleus classification engine 518, which will each be described in more detail next.

The transformation engine 504 can be configured to apply one or more transformation operations to the synaptic connectivity graph 501 that alter the connectivity of the graph 501, i.e., by adding or removing edges from the graph. A few examples of transformation operations follow.

In one example, to apply a transformation operation to the graph 501, the transformation engine 504 can randomly sample a set of node pairs from the graph (i.e., where each node pair specifies a first node and a second node). For example, the transformation engine can sample a predefined number of node pairs in accordance with a uniform probability distribution over the set of possible node pairs. For each sampled node pair, the transformation engine 504 can modify the connectivity between the two nodes in the node pair with a predefined probability (e.g., 0.1%). In one example, the transformation engine 504 can connect the nodes by an edge (i.e., if they are not already connected by an edge) with the predefined probability. In another example, the transformation engine 504 can reverse the direction of any edge connecting the two nodes with the predefined probability. In another example, the transformation engine 504 can invert the connectivity between the two nodes with the predefined probability, i.e., by adding an edge between the nodes if they are not already connected, and by removing the edge between the nodes if they are already connected.

In another example, the transformation engine 504 can apply a convolutional filter to a representation of the graph 501 as a two-dimensional array of numerical values. As described above, the graph 501 can be represented as a two-dimensional array of numerical values where the component of the array at position (i,j) can have value 1 if the graph includes an edge pointing from node i to node j, and value 0 otherwise. The convolutional filter can have any appropriate kernel, e.g., a spherical kernel or a Gaussian kernel. After applying the convolutional filter, the transformation engine 504 can quantize the values in the array representing the graph, e.g., by rounding each value in the array to 0 or 1, to cause the array to unambiguously specify the connectivity of the graph. Applying a convolutional filter to the representation of the graph 501 can have the effect of regularizing the graph, e.g., by smoothing the values in the array representing the graph to reduce the likelihood of a component in the array having a different value than many of its neighbors.

In some cases, the graph 501 can include some inaccuracies in representing the synaptic connectivity in the biological brain. For example, the graph can include nodes that are not connected by an edge despite the corresponding neurons in the brain being connected by a synapse, or “spurious” edges that connect nodes in the graph despite the corresponding neurons in the brain not being connected by a synapse. Inaccuracies in the graph can result, e.g., from imaging artifacts or ambiguities in the synaptic resolution image of the brain that is processed to generate the graph. Regularizing the graph, e.g., by applying a convolutional filter to the representation of the graph, can increase the accuracy with which the graph represents the synaptic connectivity in the brain, e.g., by removing spurious edges.

The architecture mapping system 500 can use the feature generation engine 506 and the node classification engine 508 to determine predicted “types” 510 of the neurons corresponding to the nodes in the graph 501. The type of a neuron can characterize any appropriate aspect of the neuron. In one example, the type of a neuron can characterize the function performed by the neuron in the brain, e.g., a visual function by processing visual data, an olfactory function by processing odor data, or a memory function by retaining information. After identifying the types of the neurons corresponding to the nodes in the graph 501, the architecture mapping system 500 can identify a sub-graph 512 of the overall graph 501 based on the neuron types, and determine the neural network architecture 502 based on the sub-graph 512. The feature generation engine 506 and the node classification engine 508 are described in more detail next.

The feature generation engine 506 can be configured to process the graph 501 (potentially after it has been modified by the transformation engine 504) to generate one or more respective node features 514 corresponding to each node of the graph 501. The node features corresponding to a node can characterize the topology (i.e., connectivity) of the graph relative to the node. In one example, the feature generation engine 506 can generate a node degree feature for each node in the graph 501, where the node degree feature for a given node specifies the number of other nodes that are connected to the given node by an edge. In another example, the feature generation engine 506 can generate a path length feature for each node in the graph 501, where the path length feature for a node specifies the length of the longest path in the graph starting from the node. A path in the graph may refer to a sequence of nodes in the graph, such that each node in the path is connected by an edge to the next node in the path. The length of a path in the graph may refer to the number of nodes in the path. In another example, the feature generation engine 506 can generate a neighborhood size feature for each node in the graph 501, where the neighborhood size feature for a given node specifies the number of other nodes that are connected to the node by a path of length at most N. In this example, N can be a positive integer value. In another example, the feature generation engine 506 can generate an information flow feature for each node in the graph 501. The information flow feature for a given node can specify the fraction of the edges connected to the given node that are outgoing edges, i.e., the fraction of edges connected to the given node that point from the given node to a different node.

In some implementations, the feature generation engine 506 can generate one or more node features that do not directly characterize the topology of the graph relative to the nodes. In one example, the feature generation engine 506 can generate a spatial position feature for each node in the graph 501, where the spatial position feature for a given node specifies the spatial position in the brain of the neuron corresponding to the node, e.g., in a Cartesian coordinate system of the synaptic resolution image of the brain. In another example, the feature generation engine 506 can generate a feature for each node in the graph 501 indicating whether the corresponding neuron is excitatory or inhibitory. In another example, the feature generation engine 506 can generate a feature for each node in the graph 501 that identifies the neuropil region associated with the neuron corresponding to the node.

In some cases, the feature generation engine 506 can use weights associated with the edges in the graph in determining the node features 514. As described above, a weight value for an edge connecting two nodes can be determined, e.g., based on the area of any overlap between tolerance regions around the neurons corresponding to the nodes. In one example, the feature generation engine 506 can determine the node degree feature for a given node as a sum of the weights corresponding to the edges that connect the given node to other nodes in the graph. In another example, the feature generation engine 506 can determine the path length feature for a given node as a sum of the edge weights along the longest path in the graph starting from the node.

The node classification engine 508 can be configured to process the node features 514 to identify a predicted neuron type 510 corresponding to certain nodes of the graph 501. In one example, the node classification engine 508 can process the node features 514 to identify a proper subset of the nodes in the graph 501 with the highest values of the path length feature. For example, the node classification engine 508 can identify the nodes with a path length feature value greater than the 90th percentile (or any other appropriate percentile) of the path length feature values of all the nodes in the graph. The node classification engine 508 can then associate the identified nodes having the highest values of the path length feature with the predicted neuron type of “primary sensory neuron.” In another example, the node classification engine 508 can process the node features 514 to identify a proper subset of the nodes in the graph 501 with the highest values of the information flow feature, i.e., indicating that many of the edges connected to the node are outgoing edges. The node classification engine 508 can then associate the identified nodes having the highest values of the information flow feature with the predicted neuron type of “sensory neuron.” In another example, the node classification engine 508 can process the node features 514 to identify a proper subset of the nodes in the graph 501 with the lowest values of the information flow feature, i.e., indicating that many of the edges connected to the node are incoming edges (i.e., edges that point towards the node). The node classification engine 508 can then associate the identified nodes having the lowest values of the information flow feature with the predicted neuron type of “associative neuron.”

The architecture mapping system 500 can identify a sub-graph 512 of the overall graph 501 based on the predicted neuron types 510 corresponding to the nodes of the graph 501. A “sub-graph” may refer to a graph specified by: (i) a proper subset of the nodes of the graph 501, and (ii) a proper subset of the edges of the graph 501. FIG. 6 provides an illustration of an example sub-graph of an overall graph. In one example, the architecture mapping system 500 can select: (i) each node in the graph 501 corresponding to particular neuron type, and (ii) each edge in the graph 501 that connects nodes in the graph corresponding to the particular neuron type, for inclusion in the sub-graph 512. The neuron type selected for inclusion in the sub-graph can be, e.g., visual neurons, olfactory neurons, memory neurons, or any other appropriate type of neuron. In some cases, the architecture mapping system 500 can select multiple neuron types for inclusion in the sub-graph 512, e.g., both visual neurons and olfactory neurons.

The type of neuron selected for inclusion in the sub-graph 512 can be determined based on the task which the brain emulation neural network 516 will be configured to perform. In one example, the brain emulation neural network 516 can be configured to perform an image processing task, and neurons that are predicted to perform visual functions (i.e., by processing visual data) can be selected for inclusion in the sub-graph 512. In another example, the brain emulation neural network 516 can be configured to perform an odor processing task, and neurons that are predicted to perform odor processing functions (i.e., by processing odor data) can be selected for inclusion in the sub-graph 512. In another example, the brain emulation neural network 516 can be configured to perform an audio processing task, and neurons that are predicted to perform audio processing (i.e., by processing audio data) can be selected for inclusion in the sub-graph 512.

If the edges of the graph 501 are associated with weight values (as described above), then each edge of the sub-graph 512 can be associated with the weight value of the corresponding edge in the graph 501. The sub-graph 512 can be represented, e.g., as a two-dimensional array of numerical values, as described with reference to the graph 501.

Determining the architecture 502 of the brain emulation neural network 516 based on the sub-graph 512 rather than the overall graph 501 can result in the architecture 502 having a reduced complexity, e.g., because the sub-graph 512 has fewer nodes, fewer edges, or both than the graph 501. Reducing the complexity of the architecture 502 can reduce consumption of computational resources (e.g., memory and computing power) by the brain emulation neural network 516, e.g., enabling the brain emulation neural network 516 to be deployed in resource-constrained environments, e.g., mobile devices. Reducing the complexity of the architecture 502 can also facilitate training of the brain emulation neural network 516, e.g., by reducing the amount of training data required to train the brain emulation neural network 516 to achieve an threshold level of performance (e.g., prediction accuracy).

In some cases, the architecture mapping system 500 can further reduce the complexity of the architecture 502 using a nucleus classification engine 518. In particular, the architecture mapping system 500 can process the sub-graph 512 using the nucleus classification engine 518 prior to determining the architecture 502. The nucleus classification engine 518 can be configured to process a representation of the sub-graph 512 as a two-dimensional array of numerical values (as described above) to identify one or more “clusters” in the array.

A cluster in the array representing the sub-graph 512 may refer to a contiguous region of the array such that at least a threshold fraction of the components in the region have a value indicating that an edge exists between the pair of nodes corresponding to the component. In one example, the component of the array in position (i,j) can have value 1 if an edge exists from node i to node j, and value 0 otherwise. In this example, the nucleus classification engine 518 can identify contiguous regions of the array such that at least a threshold fraction of the components in the region have the value 1. The nucleus classification engine 518 can identify clusters in the array representing the sub-graph 512 by processing the array using a blob detection algorithm, e.g., by convolving the array with a Gaussian kernel and then applying the Laplacian operator to the array. After applying the Laplacian operator, the nucleus classification engine 518 can identify each component of the array having a value that satisfies a predefined threshold as being included in a cluster.

Each of the clusters identified in the array representing the sub-graph 512 can correspond to edges connecting a “nucleus” (i.e., group) of related neurons in brain, e.g., a thalamic nucleus, a vestibular nucleus, a dentate nucleus, or a fastigial nucleus. After the nucleus classification engine 518 identifies the clusters in the array representing the sub-graph 512, the architecture mapping system 500 can select one or more of the clusters for inclusion in the sub-graph 512. The architecture mapping system 500 can select the clusters for inclusion in the sub-graph 512 based on respective features associated with each of the clusters. The features associated with a cluster can include, e.g., the number of edges (i.e., components of the array) in the cluster, the average of the node features corresponding to each node that is connected by an edge in the cluster, or both. In one example, the architecture mapping system 500 can select a predefined number of largest clusters (i.e., that include the greatest number of edges) for inclusion in the sub-graph 512.

The architecture mapping system 500 can reduce the sub-graph 512 by removing any edge in the sub-graph 512 that is not included in one of the selected clusters, and then map the reduced sub-graph 512 to a corresponding neural network architecture, as will be described in more detail below. Reducing the sub-graph 512 by restricting it to include only edges that are included in selected clusters can further reduce the complexity of the architecture 502, thereby reducing computational resource consumption by the brain emulation neural network 516 and facilitating training of the brain emulation neural network 516.

The architecture mapping system 500 can determine the architecture 502 of the brain emulation neural network 516 from the sub-graph 512 in any of a variety of ways. For example, the architecture mapping system 500 can map each node in the sub-graph 512 to a corresponding: (i) artificial neuron, (ii) artificial neural network layer, or (iii) group of artificial neural network layers in the architecture 502, as will be described in more detail next.

In one example, the neural network architecture 502 can include: (i) a respective artificial neuron corresponding to each node in the sub-graph 512, and (ii) a respective connection corresponding to each edge in the sub-graph 512. In this example, the sub-graph 512 can be a directed graph, and an edge that points from a first node to a second node in the sub-graph 512 can specify a connection pointing from a corresponding first artificial neuron to a corresponding second artificial neuron in the architecture 502. The connection pointing from the first artificial neuron to the second artificial neuron can indicate that the output of the first artificial neuron should be provided as an input to the second artificial neuron. Each connection in the architecture can be associated with a weight value, e.g., that is specified by the weight value associated with the corresponding edge in the sub-graph. An artificial neuron may refer to a component of the architecture 502 that is configured to receive one or more inputs (e.g., from one or more other artificial neurons), and to process the inputs to generate an output. The inputs to an artificial neuron and the output generated by the artificial neuron can be represented as scalar numerical values. In one example, a given artificial neuron can generate an output b as:

$$b = σ ( {\sum }_{i = 1}^{n} {w}_{i} \cdot {a}_{i} ) \qquad ( 1 )$$

where σ(·) is a non-linear “activation” function (e.g., a sigmoid function or an arctangent function), {aᵢ}ᵢ₌₁ⁿ are the inputs provided to the given artificial neuron, and {wᵢ}ᵢ₌₁ⁿ are the weight values associated with the connections between the given artificial neuron and each of the other artificial neurons that provide an input to the given artificial neuron.

In another example, the sub-graph 512 can be an undirected graph, and the architecture mapping system 500 can map an edge that connects a first node to a second node in the sub-graph 512 to two connections between a corresponding first artificial neuron and a corresponding second artificial neuron in the architecture. In particular, the architecture mapping system 500 can map the edge to: (i) a first connection pointing from the first artificial neuron to the second artificial neuron, and (ii) a second connection pointing from the second artificial neuron to the first artificial neuron.

In another example, the sub-graph 512 can be an undirected graph, and the architecture mapping system can map an edge that connects a first node to a second node in the sub-graph 512 to one connection between a corresponding first artificial neuron and a corresponding second artificial neuron in the architecture. The architecture mapping system 500 can determine the direction of the connection between the first artificial neuron and the second artificial neuron, e.g., by randomly sampling the direction in accordance with a probability distribution over the set of two possible directions.

In some cases, the edges in the sub-graph 512 is not be associated with weight values, and the weight values corresponding to the connections in the architecture 502 can be determined randomly. For example, the weight value corresponding to each connection in the architecture 502 can be randomly sampled from a predetermined probability distribution, e.g., a standard Normal (N(0,1)) probability distribution.

In another example, the neural network architecture 502 can include: (i) a respective artificial neural network layer corresponding to each node in the sub-graph 512, and (ii) a respective connection corresponding to each edge in the sub-graph 512. In this example, a connection pointing from a first layer to a second layer can indicate that the output of the first layer should be provided as an input to the second layer. An artificial neural network layer may refer to a collection of artificial neurons, and the inputs to a layer and the output generated by the layer can be represented as ordered collections of numerical values (e.g., tensors of numerical values). In one example, the architecture 502 can include a respective convolutional neural network layer corresponding to each node in the sub-graph 512, and each given convolutional layer can generate an output d as:

$$d = σ ( {h}_{θ} ( {\sum }_{i = 1}^{n} {w}_{i} \cdot {c}_{i} ) ) \qquad ( 2 )$$

where each cᵢ(i=1, . . . , n) is a tensor (e.g., a two- or three- dimensional array) of numerical values provided as an input to the layer, each wᵢ(i=1, . . . , n) is a weight value associated with the connection between the given layer and each of the other layers that provide an input to the given layer (where the weight value for each edge can be specified by the weight value associated with the corresponding edge in the sub-graph), h_{θ}(·) represents the operation of applying one or more convolutional kernels to an input to generate a corresponding output, and σ(·) is a non-linear activation function that is applied element-wise to each component of its input. In this example, each convolutional kernel can be represented as an array of numerical values, e.g., where each component of the array is randomly sampled from a predetermined probability distribution, e.g., a standard Normal probability distribution.

In another example, the architecture mapping system 500 can determine that the neural network architecture includes: (i) a respective group of artificial neural network layers corresponding to each node in the sub-graph 512, and (ii) a respective connection corresponding to each edge in the sub-graph 512. The layers in a group of artificial neural network layers corresponding to a node in the sub-graph 512 can be connected, e.g., as a linear sequence of layers, or in any other appropriate manner.

The neural network architecture 502 can include one or more artificial neurons that are identified as “input” artificial neurons and one or more artificial neurons that are identified as “output” artificial neurons. An input artificial neuron may refer to an artificial neuron that is configured to receive an input from a source that is external to the brain emulation neural network 516. An output artificial neural neuron may refer to an artificial neuron that generates an output which is considered part of the overall output generated by the brain emulation neural network 516.

Various operations performed by the described architecture mapping system 500 are optional or can be implemented in a different order. For example, the architecture mapping system 500 can refrain from applying transformation operations to the graph 501 using the transformation engine 504, and refrain from extracting a sub-graph 512 from the graph 501 using the feature generation engine 506, the node classification engine 508, and the nucleus classification engine 518. In this example, the architecture mapping system 500 can directly map the graph 501 to the neural network architecture 502, e.g., by mapping each node in the graph to an artificial neuron and mapping each edge in the graph to a connection in the architecture, as described above.

FIG. 6 illustrates an example graph 600 and an example sub-graph 602. Each node in the graph 600 is represented by a circle (e.g., 604 and 606), and each edge in the graph 600 is represented by a line (e.g., 608 and 610). In this illustration, the graph 600 can be considered a simplified representation of a synaptic connectivity graph (an actual synaptic connectivity graph can have far more nodes and edges than are depicted in FIG. 6). A sub-graph 602 can be identified in the graph 600, where the sub-graph 602 includes a proper subset of the nodes and edges of the graph 600. In this example, the nodes included in the sub-graph 602 are hatched (e.g., 606) and the edges included in sub-graph 602 are dashed (e.g., 610). The nodes included in the sub-graph 602 can correspond to neurons of a particular type, e.g., neurons having a particular function, e.g., olfactory neurons, visual neurons, or memory neurons. The architecture of the brain emulation neural network can be specified by the structure of the entire graph 600, or by the structure of a sub-graph 602, as described above.

FIG. 7 is a flow diagram of an example process 700 for implementing a brain emulation subnetwork using a compressed matrix representation. For convenience, the process 700 will be described as being performed by a system of one or more computers located in one or more locations. For example, a neural network computing system, e.g., the neural network computing system 100 depicted in FIG. 1, appropriately programmed in accordance with this specification, can perform the process 700.

The brain emulation subnetwork is a component of a neural network that is configured to process a network input to generate a network output.

The system process the network input using an input subnetwork of the neural network to generate an embedding of the network input (step 702). For example, the input subnetwork can be a trained subnetwork, e.g., the first trained subnetwork 204 depicted in FIG. 2. As another example, the output subnetwork can be another brain emulation subnetwork.

The system processing the embedding of the network input using the brain emulation subnetwork to generate a brain emulation subnetwork output (step 704). The brain emulation subnetwork include brain emulation parameters that each correspond to a respective synaptic connection between a respective pair of biological neurons in the brain of a biological organism. Values for the brain emulation parameters can be specified by synaptic connectivity between the biological neurons in the brain of the biological organism.

To generate the brain emulation subnetwork output, the system can obtain a compressed matrix representation of a sparse matrix that includes the brain emulation parameters. The sparse matrix represents the architecture of the brain emulation subnetwork. The system can then apply the compressed matrix representation to the embedding of the network input to generate the brain emulation subnetwork output.

The system processes the brain emulation subnetwork output using an output subnetwork of the neural network to generate the network output (step 706). For example, the output subnetwork can be a trained subnetwork, e.g., the second trained subnetwork 212 depicted in FIG. 2. As another example, the output subnetwork can be another brain emulation subnetwork.

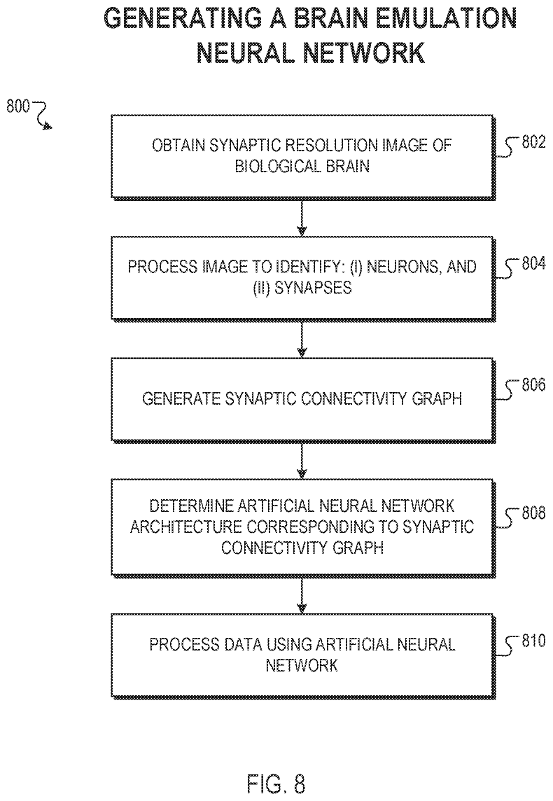

FIG. 8 is a flow diagram of an example process 800 for generating a brain emulation neural network. For convenience, the process 800 will be described as being performed by a system of one or more computers located in one or more locations.

The system obtains a synaptic resolution image of at least a portion of a brain of a biological organism (802).

The system processes the image to identify: (i) neurons in the brain, and (ii) synaptic connections between the neurons in the brain (804).

The system generates data defining a graph representing synaptic connectivity between the neurons in the brain (806). The graph includes a set of nodes and a set of edges, where each edge connects a pair of nodes. The system identifies each neuron in the brain as a respective node in the graph, and each synaptic connection between a pair of neurons in the brain as an edge between a corresponding pair of nodes in the graph.

The system determines an artificial neural network architecture corresponding to the graph representing the synaptic connectivity between the neurons in the brain (808).

The system processes a network input using an artificial neural network having the artificial neural network architecture to generate a network output (810).

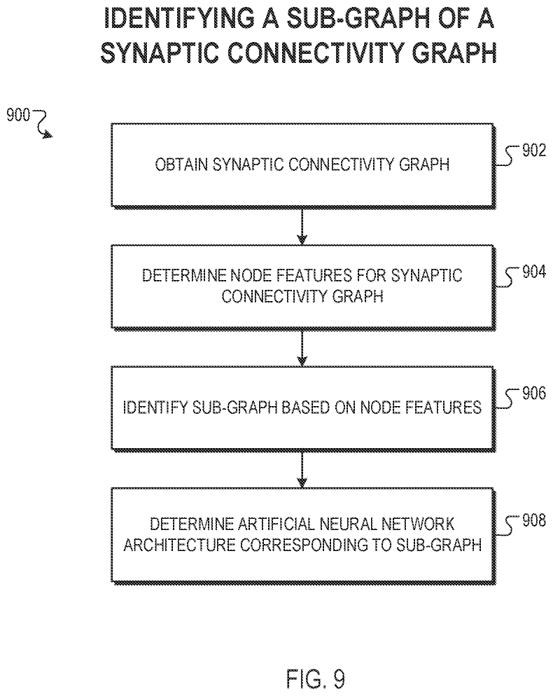

FIG. 9 is a flow diagram of an example process 900 for determining an artificial neural network architecture corresponding to a sub-graph of a synaptic connectivity graph. For convenience, the process 900 will be described as being performed by a system of one or more computers located in one or more locations. For example, an architecture mapping system, e.g., the architecture mapping system 500 of FIG. 5, appropriately programmed in accordance with this specification, can perform the process 900.

The system obtains data defining a graph representing synaptic connectivity between neurons in a brain of a biological organism (902). The graph includes a set of nodes and edges, where each edge connects a pair of nodes. Each node corresponds to a respective neuron in the brain of the biological organism, and each edge connecting a pair of nodes in the graph corresponds to a synaptic connection between a pair of neurons in the brain of the biological organism.

The system determines, for each node in the graph, a respective set of one or more node features characterizing a structure of the graph relative to the node (904).

The system identifies a sub-graph of the graph (906). In particular, the system selects a proper subset of the nodes in the graph for inclusion in the sub-graph based on the node features of the nodes in the graph.

The system determines an artificial neural network architecture corresponding to the sub-graph of the graph (908).

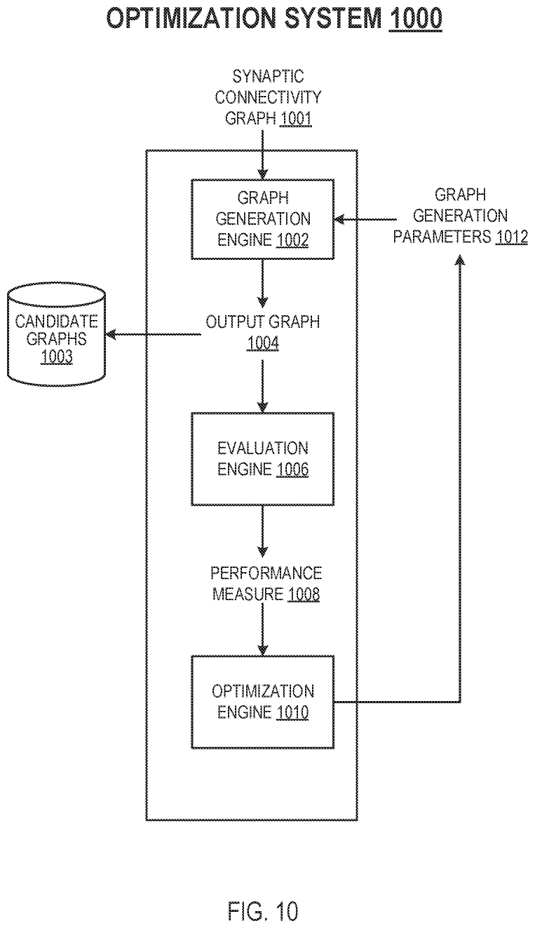

FIG. 10 shows an example optimization system 1000. The optimization system 1000 is an example of a system implemented as computer programs on one or more computers in one or more locations in which the systems, components, and techniques described below are implemented.

The optimization system 1000 is configured to generate candidate graphs 1003 using a graph generation engine 1002. The graph generation engine 1002 is configured to process a synaptic connectivity graph 1001 in accordance with a set of graph generation parameters 1012 to generate an output graph 1004 that is added to the set of candidate graphs 1003. The optimization system 1000 iteratively optimizes the parameters 1012 of the graph generation engine 1002 using an optimization engine 1010 to increase the performance measures 1008 of the output graphs 1004 generated by the graph generation engine 1002, as will be described in more detail below.

The parameters 1012 of the graph generation engine 1002 specify transformation operations that are applied to the synaptic connectivity graph 1001 to generate an output graph 1004. The graph generation engine 1002 may generate the output graph 1004 by applying transformation operations to a representation of the synaptic connectivity graph 1001 as a two-dimensional array of numerical values. As described above, a graph may be represented as a two-dimensional array of numerical values with a number of rows and columns equal to the number of nodes in the graph. The component of the array at position (i,j) may have value 1 if the graph includes an edge pointing from node i to node j, and value 0 otherwise.

In one example, as part of generating an output graph 1004, the graph generation engine 1002 may apply a convolutional filtering operation specified by a filtering kernel to the array representing the synaptic connectivity graph 1001. In this example, the graph generation parameters 1012 may specify the components of a matrix defining the filtering kernel.

In another example, as part of generating an output graph 1004, the graph generation engine 1002 may apply a “shifting” operation to the array representing the synaptic connectivity graph 1001, e.g., such that each the value in each component of the array is translated “left”, “right”, “up”, or “down”. Components that are shifted outside the bounds of the array may be wrapped around the opposite side of the array. In this example, the graph generation parameters 1012 may specify the direction and magnitude of the shifting operation.

In another example, as part of generating an output graph, the graph generation engine may apply a cropping operation to the adjacency matrix representing the synaptic connectivity graph, where the cropping operation replaces the adjacency matrix representing the synaptic connectivity graph with an adjacency matrix representing a sub-graph of the synaptic connectivity graph. Generally, a “sub-graph” may refer to a graph specified by: (i) a proper subset of the nodes of the synaptic connectivity graph, and (ii) a proper subset of the edges of the synaptic connectivity graph. The cropping operation may specify a sub-graph of synaptic connectivity graph, e.g., by specifying a proper subset of the rows and a proper subset of the columns of the adjacency matrix representing the synaptic connectivity graph that define a sub-matrix of the adjacency matrix. The sub-graph may include: (i) each edge specified by the sub-matrix, and (ii) each node that is connected by an edge specified by the sub-matrix.

At each of multiple iterations, the graph generation engine 1002 processes the synaptic connectivity graph 1001 in accordance with the current values of the graph generation parameters 1012 to generate an output graph 1004 which may then be added to the set of candidate graphs 1003. The optimization system 1000 determines a performance measure 1008 of the output graph 1004 using an evaluation engine 1006, and then provides the performance measure 1008 of the output graph 1004 to the optimization engine 1010.

In some implementations, each edge of the synaptic connectivity graph may be associated with a weight value that is determined from the synaptic resolution image of the brain, as described above. Each candidate graph may inherit the weight values associated with the edges of the synaptic connectivity graph. For example, each edge in the candidate graph that corresponds to an edge in the synaptic connectivity graph may be associated with the same weight value as the corresponding edge in the synaptic connectivity graph. Edges in the candidate graph that do not correspond to edges in the synaptic connectivity graph may be associated with default or randomly initialized weight values.

The performance measure for a candidate graph characterizes the performance of a neural network that includes a brain emulation neural network layer having an architecture specified by the candidate graph at performing a machine learning task. More specifically, to determine the performance measure of a candidate graph, the evaluation system 1006 can map the candidate graph to a corresponding brain emulation neural network layer, e.g., using the architecture mapping system 420 described with reference to FIG. 4B, e.g., by mapping each node in the candidate graph to an artificial neuron in the brain emulation neural network layer, each edge in the candidate graph to a connection between a corresponding pair of artificial neurons in the brain emulation neural network layer, and the weight value associated with each edge in the candidate graph to a parameter value associated with the corresponding connection in the brain emulation neural network layer.

The evaluation engine may measure the performance of a neural network that includes a brain emulation neural network layer having an architecture specified by the candidate graph (e.g., the neural network 102 described with reference to FIG. 1), e.g., by training the neural network on a set of training data, and then evaluating the performance of the trained neural network on a set of validation data. Both the training data and the validation data may include training examples, where each training example specifies: (i) a network input, and (ii) a target output, i.e., that should be generated by processing the network input. In determining the performance measure of a neural network, the evaluation engine trains the neural network on the training data, but reserves the validation data for evaluating the performance of the trained neural network (i.e., by not training the neural network on the validation data). The evaluation engine may evaluate the performance of the trained neural network on the validation data, e.g., by using an objective function to measure an error between: (i) the target outputs specified by the validation data, and (ii) the predicted outputs generated by the trained neural network. The objective function may be, e.g., a squared-error objective function, or any other appropriate objective function.

The optimization engine 1010 is configured to process the performance measures 1008 of the output graphs 1004 to determine adjustments to the current values of the graph generation parameters to encourage the generation of output graphs with higher performance measures. Prior to the first iteration, the values of the graph generation parameters 1012 may be set to default values or randomly initialized. The optimization engine 1010 may use any appropriate optimization technique, e.g., a “black-box” optimization technique that does not rely on computing gradients of the transformation operations applied by the graph generation engine 1002. Examples of black-box optimization techniques which may be implemented by the optimization engine 1010 are described with reference to: Golovin, D., Solnik, B., Moitra, S., Kochanski, G., Karro, J., & Sculley, D.: “Google vizier: A service for black-box optimization,” In Proceedings of the 23rd ACM SIGKDD International Conference on Knowledge Discovery and Data Mining, pp. 1487-1495 (2017).

After the final iteration, the optimization system 1000 may identify a best-performing candidate graph based on the performance measures. For example, the optimization system may identify the best-performing graph as the candidate graph with the highest performance measure. After identifying the best-performing graph, the optimization system may provide the brain emulation neural network layer specified by the best-performing graph for use as part of a neural network, e.g., the neural network 102 described with reference to FIG. 1.

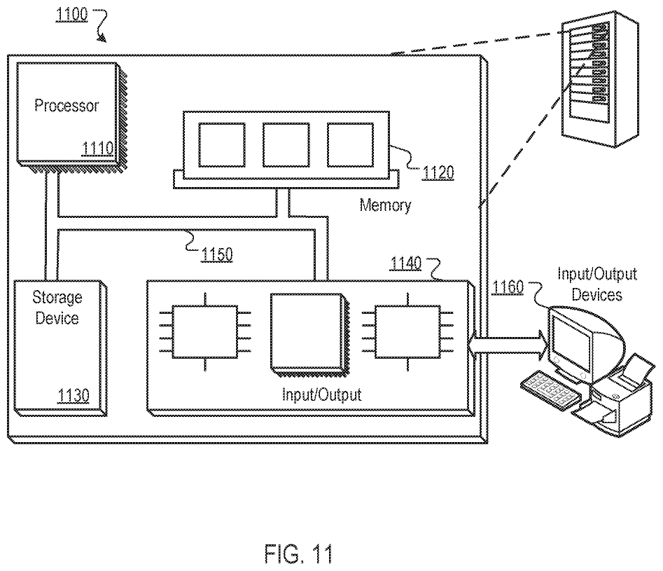

FIG. 11 is a block diagram of an example computer system 1100 that can be used to perform operations described previously. The system 1100 includes a processor 1110, a memory 1120, a storage device 1130, and an input/output device 1140. Each of the components 1110, 1120, 1130, and 1140 can be interconnected, for example, using a system bus 1150. The processor 1110 is capable of processing instructions for execution within the system 1100. In one implementation, the processor 1110 is a single-threaded processor. In another implementation, the processor 1110 is a multi-threaded processor. The processor 1110 is capable of processing instructions stored in the memory 1120 or on the storage device 1130.

The memory 1120 stores information within the system 1100. In one implementation, the memory 1120 is a computer-readable medium. In one implementation, the memory 1120 is a volatile memory unit. In another implementation, the memory 1120 is a non-volatile memory unit.

The storage device 1130 is capable of providing mass storage for the system 1100. In one implementation, the storage device 1130 is a computer-readable medium. In various different implementations, the storage device 1130 can include, for example, a hard disk device, an optical disk device, a storage device that is shared over a network by multiple computing devices (for example, a cloud storage device), or some other large capacity storage device.

The input/output device 1140 provides input/output operations for the system 1100. In one implementation, the input/output device 1140 can include one or more network interface devices, for example, an Ethernet card, a serial communication device, for example, and RS-232 port, and/or a wireless interface device, for example, and 802.11 card. In another implementation, the input/output device 1140 can include driver devices configured to receive input data and send output data to other input/output devices, for example, keyboard, printer and display devices 1160. Other implementations, however, can also be used, such as mobile computing devices, mobile communication devices, and set-top box television client devices.

Although an example processing system has been described in FIG. 11, implementations of the subject matter and the functional operations described in this specification can be implemented in other types of digital electronic circuitry, or in computer software, firmware, or hardware, including the structures disclosed in this specification and their structural equivalents, or in combinations of one or more of them.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non-transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application-specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program which may also be referred to or described as a program, software, a software application, an app, a module, a software module, a script, or code) can be written in any form of programming language, including compiled or interpreted languages, or declarative or procedural languages, and it can be deployed in any form, including as a stand-alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a data communication network.

For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

As used in this specification, an “engine,” or “software engine,” refers to a software implemented input/output system that provides an output that is different from the input. An engine can be an encoded block of functionality, such as a library, a platform, a software development kit (“SDK”), or an object. Each engine can be implemented on any appropriate type of computing device, e.g., servers, mobile phones, tablet computers, notebook computers, music players, e-book readers, laptop or desktop computers, PDAs, smart phones, or other stationary or portable devices, that includes one or more processors and computer readable media. Additionally, two or more of the engines may be implemented on the same computing device, or on different computing devices.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read-only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and pointing device, e.g, a mouse, trackball, or a presence sensitive display or other surface by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone, running a messaging application, and receiving responsive messages from the user in return.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface, a web browser, or an app through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

In addition to the embodiments described above, the following embodiments are also innovative:

Embodiment 1 is a method comprising:

obtaining a network input; and

processing the network input using a neural network to generate a network output, comprising:
processing the network input using an input subnetwork of the neural network to generate an embedding of the network input;
processing the embedding of the network input using a brain emulation subnetwork of the neural network, wherein the brain emulation subnetwork has a brain emulation neural network architecture that represents synaptic connectivity between a plurality of biological neurons in a brain of a biological organism, the processing comprising:
   obtaining a compressed matrix representation of a sparse matrix of brain emulation parameters representing synaptic connectivity between the plurality of biological neurons in the brain of the biological organism; and
   applying the compressed matrix representation to the embedding of the network input to generate a brain emulation subnetwork output; and
processing the brain emulation subnetwork output using an output subnetwork of the neural network to generate the network output.

Embodiment 2 is the method of embodiment 1, wherein the compressed matrix representation identifies only a proper subset of the brain emulation parameters of the sparse matrix.

Embodiment 3 is the method of embodiment 2, wherein the compressed matrix representation identifies only brain emulation parameters in the sparse matrix that have non-zero values, and excludes brain emulation parameters in the sparse matrix having value zero.

Embodiment 4 is the method of any one of embodiments 2 or 3, wherein the compressed matrix representation identifies: (i) all brain emulation parameters in the sparse matrix that have non-zero values, and (ii) a proper subset of brain emulation parameters in the sparse matrix having value zero.

Embodiment 5 is the method of any one of embodiments 1-4, wherein the compressed matrix representation comprises data defining: (i) a respective value, and (ii) a respective position in the sparse matrix, of each brain emulation parameter that is identified in the compressed matrix representation.

Embodiment 6 is the method of any one of embodiments 1-5, wherein the sparse matrix comprises at least 100 million brain emulation parameters.

Embodiment 7 is the method of any one of embodiments 1-6, wherein at least 90% of brain emulation parameters in the sparse matrix have value zero.

Embodiment 8 is the method of any one of embodiments 1-7, wherein the sparse matrix representing synaptic connectivity between the plurality of biological neurons is a two-dimensional matrix of brain emulation parameters arranged into a plurality of rows and a plurality of columns,

wherein each row and each column of the sparse matrix correspond to a respective biological neuron from the plurality of biological neurons, and

wherein each brain emulation parameter of the sparse matrix corresponds to a respective pair of biological neurons in the brain of the biological organism, the pair comprising: (i) the biological neuron corresponding to a row of the brain emulation parameter in the sparse matrix, and (ii) the biological neuron corresponding to a column of the brain emulation parameter in the sparse matrix.

Embodiment 9 is the method of embodiment 8, wherein each brain emulation parameter of the sparse matrix has a respective value that characterizes synaptic connectivity in the brain of the biological organism between the respective pair of biological neurons corresponding to the brain emulation parameter.

Embodiment 10 is the method of embodiment 9, wherein each brain emulation parameter of the sparse matrix that corresponds to a respective pair of biological neurons that are not connected by a synaptic connection in the brain of the biological organism has value zero.

Embodiment 11 is the method of any one of embodiments 9 or 10, wherein each brain emulation parameter of the sparse matrix that corresponds to a respective pair of biological neurons that are connected by a synaptic connection in the brain of the biological organism has a respective non-zero value that is based on a proximity of the pair of biological neurons in the brain of the biological organism.

Embodiment 12 is the method of any one of embodiments 1-11, wherein applying the compressed matrix representation to the embedding of the network input to generate the brain emulation subnetwork output comprises:

determining the brain emulation subnetwork output to be a result of a matrix multiplication of: (i) the sparse matrix represented by the compressed matrix representation, and (ii) the embedding of the network input, without performing any scalar multiplications by brain emulation parameters of the sparse matrix that are not identified in the compressed matrix representation.

Embodiment 13 is the method of any one of embodiments 1-12, further comprising training a plurality of neural network parameters of the neural network to optimize an objective function, the training comprising, at each of a plurality of training iterations:

processing one or more network inputs using the neural network, in accordance with current values of the plurality of neural network parameters, to generate corresponding network outputs;

determining gradients, with respect to the neural network parameters, of an objective function that depends on the network outputs; and

updating the current values of the neural network parameters using the gradients.

Embodiment 14 is the method of embodiment 13, wherein updating the current values of the neural network parameters using the gradients comprises updating current values of the brain emulation parameters of the sparse matrix,

wherein updating the current values of the brain emulation parameters of the sparse matrix only modifies brain emulation parameters that are identified in the compressed matrix representation without modifying brain emulation parameters that are not identified in the compressed matrix representation.

Embodiment 15 is the method of any one of embodiments 13 or 14, wherein the training further comprises, at each of a plurality of training iterations:

removing one or more brain emulation parameters from the compressed matrix representation of the sparse matrix; and

adding one or more new brain emulation parameters to the compressed matrix representation of the sparse matrix.

Embodiment 16 is the method of embodiment 15, wherein removing one or more brain emulation parameters from the compressed matrix representation of the sparse matrix comprises one or more of:

for each brain emulation parameter in the compressed matrix representation, randomly selecting the brain emulation parameter for removal with a likelihood that is inversely proportional with a magnitude of the value of the brain emulation parameter;

for each brain emulation parameter in the compressed matrix representation, randomly selecting the brain emulation parameter for removal with a likelihood that is inversely proportional with a rank of the magnitude of the value of the brain emulation parameter in a ranking of the magnitudes of the values of the brain emulation parameters; or

performing a multi-stage process comprising:
a first stage comprising generating a set of candidate brain emulation parameters by randomly sampling the candidate brain emulation parameters according to a ranking of the magnitudes of the values of the brain emulation parameters; and
a second stage comprising randomly selecting brain emulations parameters from the set of candidate brain emulation parameters for removal according to the magnitudes of the values of the candidate brain emulation parameters.

Embodiment 17 is the method of any one of embodiments 15 or 16, wherein adding one or more new brain emulation parameters to the compressed matrix representation of the sparse matrix comprises:

randomly selecting one or more brain emulation parameters that are not identified in the compressed matrix representation; and

for each randomly selected brain emulation parameter, adding the randomly selected brain emulation parameter to the compressed matrix representation, and assigning an initial value of zero to the randomly selected brain emulation parameter.

Embodiment 18 is the method of any one of embodiments 1-17, wherein the sparse matrix of brain emulation parameters representing synaptic connectivity between the plurality of biological neurons in the brain of the biological organism is determined from a synaptic resolution image of at least a portion of the brain of the biological organism, the determining comprising:

processing the synaptic resolution image to identify: (i) the plurality of biological neurons, and (ii) a plurality of synaptic connections between pairs of biological neurons; and

determining a respective value for each brain emulation parameter in the sparse matrix, comprising:
setting a value of each brain emulation parameter that corresponds to a pair of biological neurons in the brain that are not connected by a synapse to zero; and
setting a value of each brain emulation parameter that corresponds to a pair of biological neurons in the brain that are connected by a synapse based on a proximity of the pair of biological neurons in the brain.

Embodiment 19 is a system comprising: one or more computers and one or more storage devices storing instructions that are operable, when executed by the one or more computers, to cause the one or more computers to perform the method of any one of embodiments 1 to 18.

Embodiment 20 is one or more non-transitory computer storage media encoded with a computer program, the program comprising instructions that are operable, when executed by data processing apparatus, to cause the data processing apparatus to perform the method of any one of embodiments 1 to 18.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain some cases, multitasking and parallel processing may be advantageous.

What is claimed is:

1. A method comprising:
obtaining a network input; and
processing the network input using a neural network to generate a network output, comprising:
processing the network input using an input subnetwork of the neural network to generate an embedding of the network input;
processing the embedding of the network input using a brain emulation subnetwork of the neural network, wherein the brain emulation subnetwork has a brain emulation neural network architecture that represents synaptic connectivity between a plurality of biological neurons in a brain of a biological organism, the processing comprising:
obtaining a compressed matrix representation of a sparse matrix of brain emulation parameters representing synaptic connectivity between the plurality of biological neurons in the brain of the biological organism; and
applying the compressed matrix representation to the embedding of the network input to generate a brain emulation subnetwork output; and
processing the brain emulation subnetwork output using an output subnetwork of the neural network to generate the network output.

2. The method of claim 1, wherein the compressed matrix representation identifies only a proper subset of the brain emulation parameters of the sparse matrix.

3. The method of claim 2, wherein the compressed matrix representation identifies only brain emulation parameters in the sparse matrix that have non-zero values, and excludes brain emulation parameters in the sparse matrix having value zero.

4. The method of claim 2, wherein the compressed matrix representation identifies: (i) all brain emulation parameters in the sparse matrix that have non-zero values, and (ii) a proper subset of brain emulation parameters in the sparse matrix having value zero.

5. The method of claim 1, wherein the compressed matrix representation comprises data defining: (i) a respective value, and (ii) a respective position in the sparse matrix, of each brain emulation parameter that is identified in the compressed matrix representation.

6. The method of claim 1, wherein the sparse matrix comprises at least 100 million brain emulation parameters.

7. The method of claim 1, wherein at least 90% of brain emulation parameters in the sparse matrix have value zero.

8. The method of claim 1, wherein the sparse matrix representing synaptic connectivity between the plurality of biological neurons is a two-dimensional matrix of brain emulation parameters arranged into a plurality of rows and a plurality of columns,
wherein each row and each column of the sparse matrix correspond to a respective biological neuron from the plurality of biological neurons, and
wherein each brain emulation parameter of the sparse matrix corresponds to a respective pair of biological neurons in the brain of the biological organism, the pair comprising: (i) the biological neuron corresponding to a row of the brain emulation parameter in the sparse matrix, and (ii) the biological neuron corresponding to a column of the brain emulation parameter in the sparse matrix.

9. The method of claim 8, wherein each brain emulation parameter of the sparse matrix has a respective value that characterizes synaptic connectivity in the brain of the biological organism between the respective pair of biological neurons corresponding to the brain emulation parameter.

10. The method of claim 9, wherein each brain emulation parameter of the sparse matrix that corresponds to a respective pair of biological neurons that are not connected by a synaptic connection in the brain of the biological organism has value zero.

11. The method of claim 9, wherein each brain emulation parameter of the sparse matrix that corresponds to a respective pair of biological neurons that are connected by a synaptic connection in the brain of the biological organism has a respective non-zero value that is based on a proximity of the pair of biological neurons in the brain of the biological organism.

12. The method of claim 1, wherein applying the compressed matrix representation to the embedding of the network input to generate the brain emulation subnetwork output comprises:
determining the brain emulation subnetwork output to be a result of a matrix multiplication of: (i) the sparse matrix represented by the compressed matrix representation, and (ii) the embedding of the network input, without performing any scalar multiplications by brain emulation parameters of the sparse matrix that are not identified in the compressed matrix representation.

13. The method of claim 1, further comprising training a plurality of neural network parameters of the neural network to optimize an objective function, the training comprising, at each of a plurality of training iterations:
processing one or more network inputs using the neural network, in accordance with current values of the plurality of neural network parameters, to generate corresponding network outputs;
determining gradients, with respect to the neural network parameters, of an objective function that depends on the network outputs; and
updating the current values of the neural network parameters using the gradients.

14. The method of claim 13, wherein updating the current values of the neural network parameters using the gradients comprises updating current values of the brain emulation parameters of the sparse matrix,
wherein updating the current values of the brain emulation parameters of the sparse matrix only modifies brain emulation parameters that are identified in the compressed matrix representation without modifying brain emulation parameters that are not identified in the compressed matrix representation.

15. The method of claim 13, wherein the training further comprises, at each of a plurality of training iterations:
removing one or more brain emulation parameters from the compressed matrix representation of the sparse matrix; and
adding one or more new brain emulation parameters to the compressed matrix representation of the sparse matrix.

16. The method of claim 15, wherein removing one or more brain emulation parameters from the compressed matrix representation of the sparse matrix comprises one or more of:
for each brain emulation parameter in the compressed matrix representation, randomly selecting the brain emulation parameter for removal with a likelihood that is inversely proportional with a magnitude of the value of the brain emulation parameter;
for each brain emulation parameter in the compressed matrix representation, randomly selecting the brain emulation parameter for removal with a likelihood that is inversely proportional with a rank of the magnitude of the value of the brain emulation parameter in a ranking of the magnitudes of the values of the brain emulation parameters; or
performing a multi-stage process comprising:
a first stage comprising generating a set of candidate brain emulation parameters by randomly sampling the candidate brain emulation parameters according to a ranking of the magnitudes of the values of the brain emulation parameters; and
a second stage comprising randomly selecting brain emulations parameters from the set of candidate brain emulation parameters for removal according to the magnitudes of the values of the candidate brain emulation parameters.

17. The method of claim 15, wherein adding one or more new brain emulation parameters to the compressed matrix representation of the sparse matrix comprises:
randomly selecting one or more brain emulation parameters that are not identified in the compressed matrix representation; and
for each randomly selected brain emulation parameter, adding the randomly selected brain emulation parameter to the compressed matrix representation, and assigning an initial value of zero to the randomly selected brain emulation parameter.

18. The method of claim 1, wherein the sparse matrix of brain emulation parameters representing synaptic connectivity between the plurality of biological neurons in the brain of the biological organism is determined from a synaptic resolution image of at least a portion of the brain of the biological organism, the determining comprising:
processing the synaptic resolution image to identify: (i) the plurality of biological neurons, and (ii) a plurality of synaptic connections between pairs of biological neurons; and
determining a respective value for each brain emulation parameter in the sparse matrix, comprising:
setting a value of each brain emulation parameter that corresponds to a pair of biological neurons in the brain that are not connected by a synapse to zero; and
setting a value of each brain emulation parameter that corresponds to a pair of biological neurons in the brain that are connected by a synapse based on a proximity of the pair of biological neurons in the brain.

19. A system comprising one or more computers and one or more storage devices storing instructions that are operable, when executed by the one or more computers, to cause the one or more computers to perform operations comprising:
obtaining a network input; and
processing the network input using a neural network to generate a network output, comprising:
processing the network input using an input subnetwork of the neural network to generate an embedding of the network input;
processing the embedding of the network input using a brain emulation subnetwork having a brain emulation neural network architecture that is based on synaptic connectivity between a plurality of biological neurons in a brain of a biological organism, comprising:
obtaining a compressed matrix representation of a sparse matrix of brain emulation parameters representing synaptic connectivity between the plurality of biological neurons in the brain of the biological organism; and
applying the compressed matrix representation to the embedding of the network input to generate a brain emulation subnetwork output; and
processing the brain emulation subnetwork output using an output subnetwork of the neural network to generate the network output.

20. One or more non-transitory storage media storing instructions that when executed by one or more computers cause the one or more computers to perform operations comprising:
obtaining a network input; and
processing the network input using a neural network to generate a network output, comprising:
processing the network input using an input subnetwork of the neural network to generate an embedding of the network input;
processing the embedding of the network input using a brain emulation subnetwork having a brain emulation neural network architecture that is based on synaptic connectivity between a plurality of biological neurons in a brain of a biological organism, comprising:
obtaining a compressed matrix representation of a sparse matrix of brain emulation parameters representing synaptic connectivity between the plurality of biological neurons in the brain of the biological organism; and
applying the compressed matrix representation to the embedding of the network input to generate a brain emulation subnetwork output; and
processing the brain emulation subnetwork output using an output subnetwork of the neural network to generate the network output.
